(19) United States
(12) Patent Application Publication
(10) Pub. No.: US 2012/0259589 A1
(43) Pub. Date: Oct. 11, 2012

(54) APPARATUSES AND METHODS FOR ANALYSIS OF SAMPLES THROUGH MULTIPLE THICKNESSES WITH BEAM-THROUGH ASSIST

(76) Inventor: Scott Alan Carpenter, Cupertino, CA (US)

(21) Appl. No.: 13/083,539

(22) Filed: Apr. 9, 2011

(51) Int. Cl. G01J 1/42; G06F 19/00

(52) U.S. Cl. 702/189; 250/393

(57) ABSTRACT

Apparatuses, methods, software, and systems for analyzing homogeneous samples containing signal emitting entities, such as, but not limited to, radioisotopes, are disclosed. The apparatuses involve sample-container apparatuses that shape samples into different thicknesses. The methods involve characteristic signal acquisition and processing in order to compute sample self-attenuation of signals emitted from within special sample-container apparatuses. An external radiation reference-source having at least one prominent characteristic signal to beam-through the sample without interfering with the radiation signals emitted by the homogeneous sample, wherein the external reference-source is affixed to the reference-source positioning device, which is affixed to the sample-container. The software pairs characteristic signals from samples of varying thicknesses; computes sample self-attenuation, transmittance, signal detection-efficiency calibration of the detection system, identifies, and quantifies signal-emitters. The systems integrate and support the methods, apparatuses, and software.

### CROSS-REFERENCE TO RELATED APPLICATIONS

This application is related to U.S. patent application Ser. No. 13/049,903 filed on Mar. 17, 2011, and entitled “APPARATUSES AND METHODS FOR ANALYSIS OF SAMPLES THROUGH MULTIPLE THICKNESSES”, the disclosures of which are incorporated herein by reference, as if fully stated here, for all purposes.

### TECHNICAL FIELD

The present disclosure is generally related to sample analysis, and in particular, it is related to correcting for sample self-attenuation of signals emitted from within the sample. Emitted signals include gamma-rays (“g-rays”), x-rays, beta-rays, and alpha-rays that often follow the decay of radioisotopes but may also include stimulated x-ray emissions from non-radioactive isotopes or any other type of signal that attenuates as it travels through a volume of homogeneous sample. One important application of this disclosure, among others, is reliable non-destructive nuclear forensic identification and quantitation of radioisotopes in a homogeneous sample.

### BACKGROUND

In conventional sample analysis methods, ‘external’ signal-emitting reference sources (‘external’ to standard-samples that are used for detection-system calibration and external to unknown-samples to be analyzed) produce beam-lines that are commonly used specifically to determine the linear attenuation of the sample composition. In this disclosure, an ‘external’ signal-emitting reference source that produces at least one beam-line, and preferably produces only one beam-line of moderately high characteristic energy) is used specifically to determine a ratio of composition-independent (‘sample-free’) counting system signal-detection-efficiencies for at least two different thicknesses of the same sample. This ratio of counting-system signal-detection-efficiencies, using at least one characteristic signal energy and when combined with the inventions of the related patent application Ser. No. 13/049,903, improves both the counting-system signal-detection-efficiency ‘calibration’ over a wide energy range and improves quantification of signal-emitters in unknown samples.

The United States Environmental Protection Agency (“EPA”) reports that over 1,000 U.S. locations are contaminated with radiation. These sites range in size from small spaces in laboratories to massive nuclear weapons facilities. Such contamination is found in air, water, and soil, as well as in equipment and buildings. Radiation levels around such contaminated sites are closely monitored. Clean-up teams use modern technologies to assess the situation and take appropriate actions to limit potential hazards to people, the environment, the economy, and equipment. Besides such sites, general soil, air, and water sampling is required around mines, wells, basement construction, underground parking garages, and lower-level dwellings to ensure that natural radionuclides left over from the formation of the Earth's crust pose no elevated health risk. It is estimated that approximately one-third of all lung cancers are due in part to inhalation of radioactive radon gas that arises from the natural radioactive decay chains. If the price and reliability of sample analysis can be improved, then wider knowledge of the local hazards posed by natural ambient radioactivity and radon can be economically measured so that mitigating action can be taken when necessary for health and safety. Then there is the entire nuclear fuel cycle, from prospecting to mining, fuel production, operational sampling, and disposition. Nuclear power plant, hospital cyclotron, and radiopharmaceutical wastes also need sampling and measurement. In addition, scientific aging studies of lake, river, and ocean sediment rely on precise and accurate quantitation of radioisotopes in the soils, especially the radioisotope lead-210 (“Pb-210”). The International Atomic Energy Agency (“IAEA”) conducts sampling for compliance. Lunar and planetary rovers conduct sampling at a great distance. However, these measurements can be expensive and complex. Therefore, there is need for simple, reliable, and economical means for analyzing homogeneous samples purported to contain signal emitters.

### SUMMARY

The present disclosure provides an apparatus for detecting radiation signals emitted from an unknown homogeneous sample. This apparatus comprises a sample container that includes a plurality of sample container configurations; each sample container configuration enables measurement of the homogeneous sample via at least two different thicknesses; an external radiation reference source having at least one prominent characteristic signal to allow signal beam-through the sample without interfering with the radiation signals emitted by the homogeneous sample, and the external reference source is held tight onto the sample holder by a positioning device; a detector system detects the radiation signals from different sample thicknesses; and a computer processes the detected signals and analyzes the sample composition by comparing radiation signals at different sample thicknesses by means of a sample analysis software program.

One of the sample container configurations comprises a plurality of sample cups, each sample cup having a different size and shape from other sample cups, so the homogeneous sample assumes a different thickness when placed into each respective sample cup. The sample cups share at least one opening to allow the homogeneous sample to be transferred from one sample cup to the other.

One exemplary sample container is comprised of two oppositely placed sample cups connected together at one or more of their shared openings in order to allow the homogeneous sample to be transferred from one sample cup to the other when the sample container is flipped 180 degrees. The two oppositely placed sample cups have the ratio of their diameters equal to \sqrt{2}:1 so that the sample thickness ratio becomes 1:2 when the homogeneous sample is transferred from one sample cup to the other sample cup.

The present disclosure provides a method for characterizing radiation signals emitted from an unknown homogeneous sample. The method comprises providing a radiation signal detecting system comprising a plurality of detectors, a computer for analyzing the sample composition, and a sample container, wherein the sample container includes a plurality of sample cups, each sample cup has a different size from other sample cups, such that the homogeneous sample forms different thickness when placed in different sample cups; performing background signal detection for each empty sample cup and determining a background signal count rate for each empty sample cup; performing reference signal detection by measuring a reference source emission having at least one prominent characteristic signal to allow signal beam-through the plurality of empty sample containers and the plurality of containers with the sample; performing calibration signal detection by measuring a standard-sample and a reference source signal sequentially in each sample-container apparatus and determining a standard signal count rate for each sample-container apparatus; subtracting the background signal count rate from standard-sample signals for each sample cup; performing the signal detection for the unknown homogeneous sample in each sample cup; subtracting the background signal count rate from the unknown homogeneous sample signals for each sample cup; measuring the characteristic signal count rates for the unknown-sample in each sample cup; verifying the characteristic signal count rates to be qualified data; and calculating the composition of the unknown homogeneous sample by comparing the characteristic signal count rates of the unknown-sample from different sample cups using a software model.

The present disclosure provides a software product embedded in a computer readable medium for providing analysis in material spectra characterization, the software product comprising: program codes for reading the emitted signals from the homogeneous sample; program codes for subtracting a background signal; program codes for subtracting a reference source signal; program codes for matching signals emitted from a different thickness of the homogeneous sample; program codes for operating on signal count rates of different thicknesses of the homogeneous sample; program codes for calibrating signal detection using a standard sample signal; and program codes for quantization of the material spectra.

Another exemplary method consistent with the current disclosure applies different sample masses. The method includes: providing a radiation signal detecting system comprising a plurality of detectors, a computer for analyzing the sample composition, and two sample-containers each having the same shape; filling the first sample-container with a first amount of the unknown homogeneous sample; filling the second sample-container with a second amount of the unknown homogeneous sample; performing background signal detection for each sample-container and determining a background signal count rate for each sample; performing reference source signal detection; performing calibration signal detection by measuring a standard sample and the reference source signal detection sequentially in each sample-container apparatus position and determining a standard signal count rate for each sample-container; subtracting the background signal count rate from standard sample signals for each container; performing the signal detection for the first unknown homogeneous sample in the first sample-container and the second unknown homogeneous sample in the second sample-container; subtracting the background signal count rate from the first and second unknown homogeneous sample signals; measuring the characteristic signal count rates for the first and second unknown samples; verifying the characteristic signal count rates to be qualified data; and calculating the composition of the first and second unknown homogeneous samples by comparing the characteristic signal count rates of the first and second unknown samples using a software model.

An exemplary software model consistent with the current disclosure applies a software product embedded in a computer readable medium for providing analysis in material spectra characterization, the software product comprising: program codes for reading the emitted signals from the homogeneous sample; program codes for subtracting a background signal; program codes for subtracting a reference source emission signal; program codes for matching signals emitted from a different thickness of the homogeneous sample; program codes for operating on signal count rates of different thicknesses of the homogeneous sample; program codes for calibrating a standard sample signals, including one of the three sets of codes: 1) codes for measuring a first reference source emission signal through one empty sample container; codes for measuring a second reference source emission signal through one sample container with the sample at a first thickness; codes for calculating the ratio of the second to the first signals for the first thickness; 2) codes for measuring a second reference source emission signal through one sample container with the sample at a first thickness; codes for measuring a third reference source emission signal through one sample container with the sample at a second thickness; codes for calculating the ratio of the third to the first signals for the second thickness; 3) codes for measuring the reference source emission signal through the sample of the first and second thickness; codes for calculating the ratio of the signals from the thicker thickness to the thinner thickness; and program codes for quantization of the material spectra.

### BRIEF DESCRIPTION OF THE DRAWINGS

The present disclosure will be readily understood by reading the detailed description together with the accompanying drawings, wherein like reference numbers designate like structural elements, and in which:

FIG. 1 shows a signal counting system setup for acquiring ambient background spectra for an empty nd: md sample container apparatus and associated reference-source positioner apparatuses in the thick (md) and thin (nd) counting positions;

FIG. 2 shows a signal counting system setup for acquiring sample-free reference-source spectra;

FIG. 3 shows a counting system setup for nd: md beam-assisted detected-fraction calibration;

FIG. 4 shows a software model for computing the beam-assisted detected-fraction calibration;

FIG. 5 software module for computing the sample linear attenuation coefficient by one of three techniques;

FIG. 6 shows a counting system setup for signal-emitter quantitation;

FIG. 7 shows a software model for computing signal-emitter quantitation;

FIG. 8 shows a counting system setup for multi-mass nd: md beam-assisted detected-fraction calibration;

FIG. 9 shows a counting system setup using nd: md wrap-around sample containers and “rabbit-ear” reference-sample positioners for beam-assisted detected-fraction calibration; and

FIG. 10 shows a counting system setup using distant reference sources to beam through air, gas, water, or other relatively weakly attenuating sample compositions to assist detected-fraction calibration and signal-emitter quantitation.

### DETAILED DESCRIPTION

### Important Terms in this Disclosure

Beam source. The beam source is also referred to as the “reference source”. The beam source is external to the sample, external on the side of the sample opposite to the detector such that emitted reference-source signals ('beam-source signals') must pass through the sample in order to be counted by the detection system. Although the reference source may not actually emit a ‘beam’, nevertheless it acts like a ‘beam source’ in the sense that only those emitted characteristic signals that are in the solid angle subtended by the detector play a role in the beam-derived, sample-free detected-fraction calibration. The purpose for the beam source is to allow computation of the ratio of ‘beam-derived’ sample-free detected-fraction calibration values

$$( {RDetF}_{Ei , bm , nd : md} = \frac{{DetF}_{Ei , bm , stnd , nd}}{{DetF}_{Ei , bm , stnd , md}} )$$

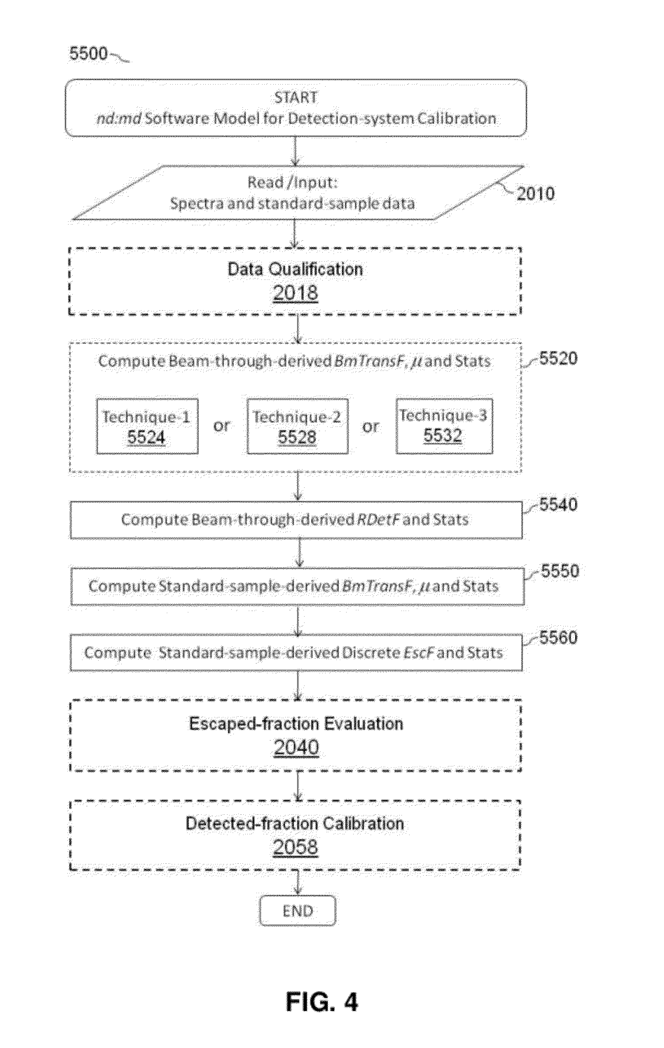

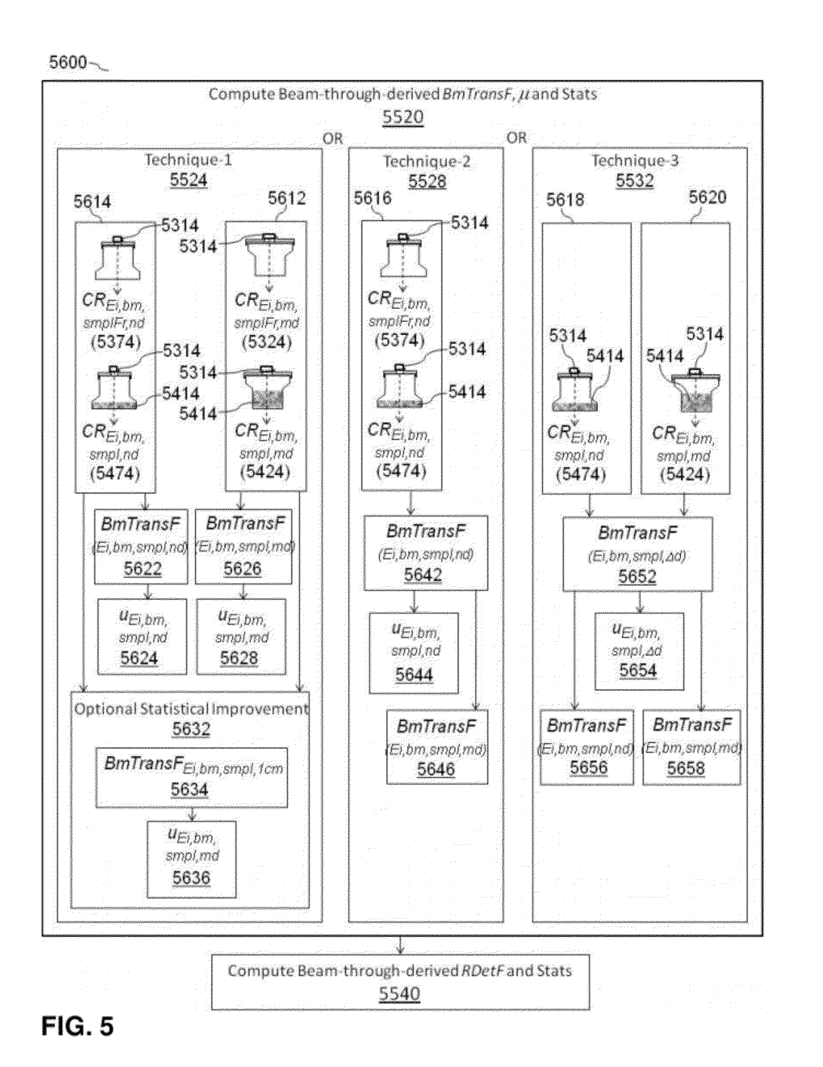

for at least two different standard-sample thicknesses (nd and md) for at least one characteristic (Eᵢ) ‘beam-source signal’. Three different techniques are described that each use the ‘beam-source signals’ to determine RDetF_{Ei,bm,nd:md}, and those three different techniques are taught in the discussion of Equations [2a] through [20b] and FIGS. 4 and 5.

Beam-through-derived terms and their values. Refers to terms and their values that are derived or computed by the use of an external reference source that acts like a beam source. See Beam source and see Standard-sample-derived terms and their values.

Characteristic signal. Characteristic signals have an emission energy (Eᵢ) that can be used to identify their signal-emitting source. Detectable gamma-ray and x-ray photons often follow nuclear decay, and they are just two types of characteristic signal.

Counting system. See Detection system.

Counts, count rates, and lines. Refers to characteristic peaks that make up an emission spectrum.

Depth (of the sample). Refers to the thickness of a sample in the direction of the detector.

Detection system. Consists of the sample-container apparatus (if there be one), reference-source positioner apparatus (if there be one), detector, vacuum system (if there be one), pulse-shaping electronics, computer control, software, and any other part or subsystem that helps the detection system collect, shape, remember, or present emitted signals.

Detected-fraction calibration. In the literature, the sample-specific and sample-free detected-fraction calibration terms are often collectively referred to as the “detection-efficiency calibration”, “counting-efficiency calibration”, “energy-efficiency calibration”, or simply the “efficiency calibration”, among others.

Multiplet (peaks). A set of overlapping peaks in a spectrum containing multiple characteristic peaks so close in characteristic energy in relation to each other that the resolving fidelity of the detector is unable to resolve them into individual singlet peaks (i.e. a series of non-overlapping characteristic peaks). See also Singlet (peak).

Operator. An operator is a general title of a person that might operate or implement the apparatuses, methods, software, and systems of this disclosure. An operator, depending on the particular activity described in this disclosure, might also be known as a technician, spectroscopist, spectrometrist, or scientist, among other related and appropriate titles.

Quantitate. To compute or calculate a quantity. Synonymous with “quantify”.

Radioisotope. Synonymous with Radionuclide. See also Signal emitter.

Reference source. See Beam source.

Sample. Any homogeneous substance that has volume. To be considered as a “sample” in this disclosure, the substance must contain at least one signal emitter. In this disclosure, samples are primarily referred to as “standard-sample”, “unknown-sample”, or simply “sample” when discussing samples in general. Standard-samples have at least some of their contents known and are used to calibrate the characteristic signal-detection efficiency of a detection system (See Detection system).

Signal emitter. Any entity that emits characteristic signals. Signal emitting entities include radioisotopes; nonradioactive isotopes; and excited elements and molecules, etc.

Singlet (peak). One non-overlapped, statistically significant characteristic peak. If there are other characteristic peaks in a given spectrum, then they will not overlap a singlet. Overlapping characteristic peaks are called multiplets. See also Multiplet (peaks).

Specific activity (SpA). The disintegration rate that occurs in a unit of mass of sample, which is commonly defined in units of curies per gram of sample (Ci/g). In this disclosure, specific activity generalizes to include the rate or quantity of total emission of any type of signal emitter.

Standard-sample-derived terms and their values. Refers to terms and their values that are derived or computed by the use of a standard-sample. See Beam-through-derived terms and their values.

I. “nd: md” Beam-Assisted Sample Analysis

In the multiple-sample-thickness analysis methods described in the related U.S. patent application Ser. No. 13/049,903, the sample self-attenuation is determined by setting equal the sample-free detected-fraction calibration terms (DetF_{Ei,smplFr,nd}≈DetF_{Ei,smplFr,md}) through at least two different sample thicknesses (nd and md where 0<n<m, and d is a unit of sample thickness). It is acknowledged in the related U.S. patent application Ser. No. 13/049,903 that sample-specific detected-fraction calibration terms computed through different thicknesses of sample are not exactly equal. To help quantify the difference between the sample-specific detected-fraction calibration terms for different sample-thickness orientations (nd and md) relative to the detection system, three new beam-thru techniques that each uses a signal-emission reference-source to beam-thru standard-samples are taught. Any one of the three techniques alone can be used to determine the ratio (RDetF_{n:m}) of the sample-specific detected-fraction calibration terms (DetF_{Ei,smplFr,nd} and DetF_{Ei,smplFr,md}), where:

$${RDetF}_{n : m} = \frac{{DetF}_{Ei , smplFr , nd}}{{DetF}_{Ei , smplFr , md}} \approx Constant for {E}_{i} ∈ \{ low , high \} \qquad [ 1 ]$$

Normally, in conventional methods, a beam-through reference source provides numerous characteristic peaks to cover the energy range of interest. But in this disclosure, only one single characteristic line is needed, so long as the line is measured through two or more unequal sample thicknesses. The ratio of the characteristic (Eᵢ) beam peak count rates (CR_{Ei,bm,smplFr,nd}, CR_{Ei,bm,smplFr,md}) through any two thicknesses of standard-sample (e.g. nd and md) allows determining the ratio (RDetF_{n:m}) of the sample-free detected-fraction calibration terms (DetF_{Ei,smplFr,nd}, DetF_{Ei,smplFr,md}), which ratio is nearly constant over a wide energy range, as indicated by Equation [1]. Multiple different characteristic beam lines can confirm this assumption, but may induce elemental fluorescence peaks, which add extra spectral noise that may interfere with characteristic peaks from the standard-sample. None of the three beam-thru techniques need be applied to unknown-samples because only standard-samples are used to determine the values of the sample-free detected-fraction calibration terms (DetF_{Ei,smplFr,nd}, DetF_{Ei,smplFr,md}) for a particular standard-sample shape, position, and orientation relative to a particular detection system.

All three beam-thru techniques can use the same type of reference signal source. The preferred properties of the signal source include (1) a single high-energy characteristic signal that doesn't interfere with the characteristic peaks from the standard-sample, but (2) not so high in energy that other negative effects occur; e.g. if the characteristic gamma-ray energy is much higher than 2-MeV, then pair production and matter-antimatter annihilation raise the background noise and degenerate the statistics of other portions of the standard-sample's characteristic emission spectrum.

“nd: md” Beam-Assisted System Setups

The nd: md beam-assisted system setups can be described in five main parts: (1) ambient background emission spectrum acquisition; (2) ambient background acquisition with reference-source auxiliary apparatus; (3) sample-free reference-source spectrum acquisition; (4) beam-assisted detected-fraction calibration; and (5) unknown-sample signal-emitter quantitation.

Part 1. “nd: md” Ambient Background Emission Spectrum Acquisition

The Part-1 system setup, i.e. ambient background emission spectrum acquisition, is disclosed in the related U.S. patent application Ser. No. 13/049,903 and will not be described again here.

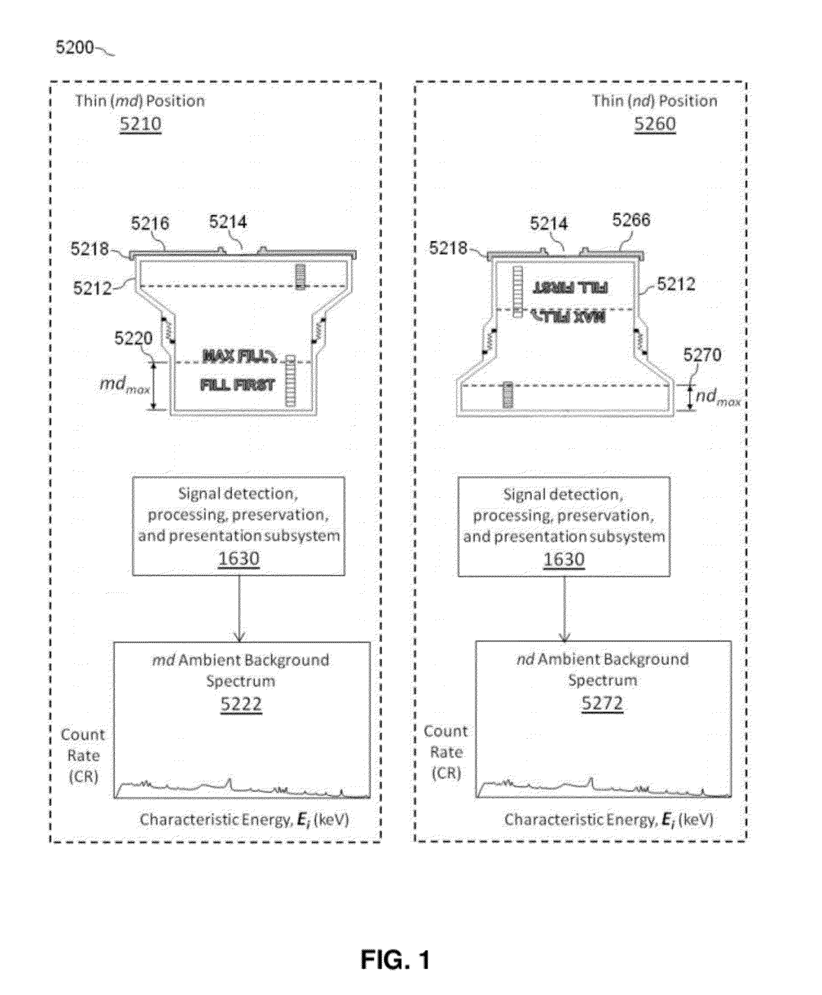

Part 2. “nd: md” Ambient Background with Auxiliary Apparatus (FIG. 1)

FIG. 1 shows a counting system setup 5200 for acquiring thick (md) 5210 and thin (nd) 5260 ambient background spectra 5222 and 5272 for the counting system; nd: md sample container 5212; reference-source positioners 5216 and 5266; and possibly other auxiliary apparatuses; e.g. reference-source back-scatter shield (not shown in FIG. 1). For this discussion, we presume that the empty nd: md sample container 5212 is first counted in the thick (md) position 5210 relative to the signal detection, processing, preservation, and presentation subsystem 1630 (and which is disclosed in detail in FIG. 16 of the related U.S. patent application Ser. No. 13/049,903. Subsystem 1630 detects, processes, preserves, and presents the nd and md ambient background spectra 5222 and 5272. The size, shape, and positions of the empty nd: md sample container with respect to the detector, should be the same as those planned for containers holding standard-samples used to calibrate the counting system and for containers holding unknown-samples to be measured and analyzed by the counting system.

In addition to the nd: md sample container 5212, there is also a reference-source positioner apparatus 5216 consisting of an edge 5218 for fastening the positioner apparatus to the wide diameter of the nd: md sample container, and consisting of a reference-source holder 5214 to secure the reference source in place (the reference source is not shown, nor is it used here). The base of the reference-source holder 5214 is a thin window of low-z material, so as to minimize the attenuation of the reference-source emission spectrum in the direction of subsystem 1630.

After an amount of counting time (t_{bkgd,md}) the counting is stopped and the empty sample-container 5212 is flipped 180 degrees to the thin (nd) position 5260 relative to subsystem 1630. The nd: md sample-container 5212 has two different diameter bases. In position 5260, a smaller-diameter reference-source positioner apparatus 5266 is installed, and it also consists of an edge 5218 for fastening the positioner apparatus to the narrow diameter of the sample container 5212, and consists of a reference-source holder 5214 to secure the reference source in place. After an amount of counting time (t_{bkgd,nd}) the counting is stopped.

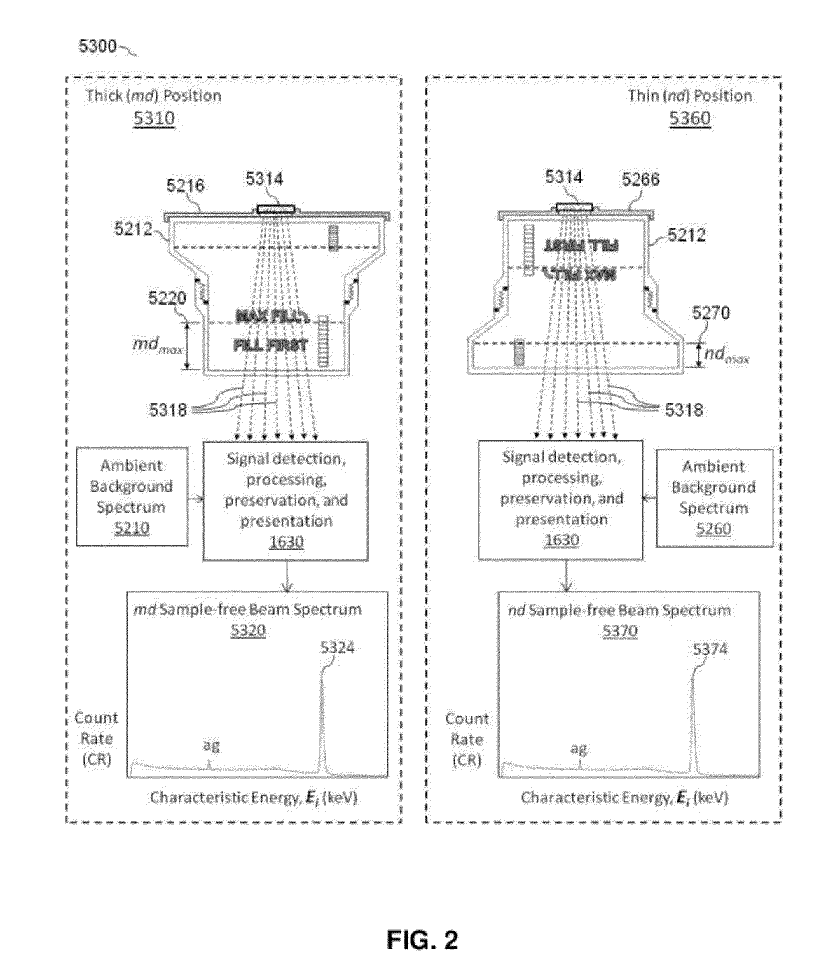

Part 3. “nd: md” Sample-Free Ref-Source Emission Spectrum (FIG. 2)

FIG. 2 illustrates the system setup 5300 for acquiring the sample-free reference-source emission spectra. Just above the empty sample container 5212 is the reference-source positioner apparatus 5216, into which is placed a signal-emitting reference-source 5314. A fraction of the characteristic signals 5318 are emitted from this reference-source within the solid angle subtended by the detector (not shown in FIG. 2). The detector is part of subsystem 1630. Because reference-sources usually have elevated (“hot”) signal-emission activity in order to provide good counting statistics and to facilitate short counting times, signal back-scatter by the surrounding materials may elevate the background noise in the detected spectrum. To minimize this noise, a collimator or back-scatter shield may be added around the reference-source (neither of which is shown in FIG. 2). A reference-source positioner apparatus 5216 fastens the reference-source 5314 to the wide diameter of the sample container 5212 when in the thick (md) position 5310. When in the thin (nd) position 5360, a reference-source positioner apparatus 5266 fastens the reference-source 5314 to the narrow diameter of the sample container 5212.

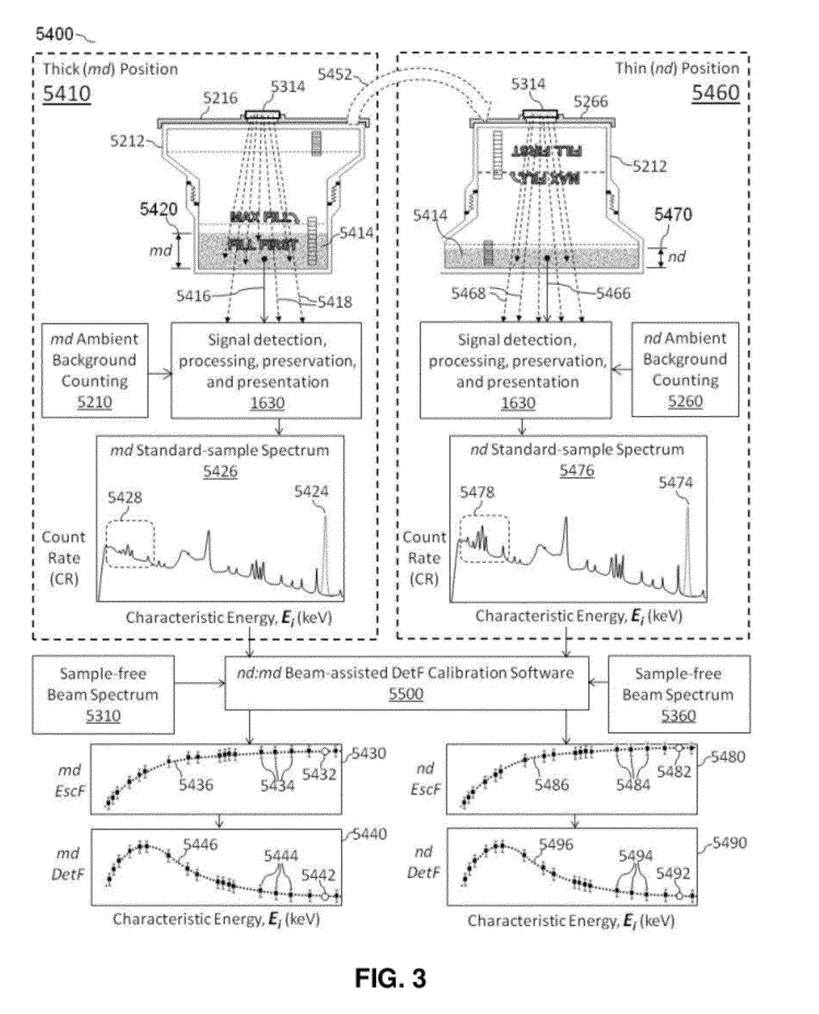

The size, shape, and positions of the empty nd: md sample container 5212, with respect to the detector, should be the same as those planned for sample containers that hold standard-samples used to calibrate the counting system 5400 in FIG. 3, and for sample containers holding unknown-samples to be analyzed by the counting system. Subsystem 1630 normalizes and subtracts-out an ambient background spectrum 5222 (in FIG. 1) from the gross sample-free beam spectrum (not shown) to produce a net sample-free beam spectrum 5320.

The ambient background spectrum is acquired by the ambient background spectrum subsystem 5210. The illustrated spectrum 5320 shows a singlet characteristic beam peak 5324 toward the high-energy range, but it is not too high in energy that the annihilation gamma-ray peak (labeled ‘ag’ in 5320)—which adds noise to the spectrum 5320—does not result in excessive degradation of the spectrum itself. After a period of counting time (t_{bm,smplFr,md}), and after a statistically ‘good enough’ beam-peak count rate is acquired (CR_{Ei,bm,smplFr,md},5324), the counting is stopped.

The reference source 5314 and its wide-diameter positioner 5216 are removed from the sample container 5212. The empty sample-container 5212 is flipped 180 degrees to the thin (nd) position 5360 relative to subsystem 1630. In position 5360, a smaller-diameter reference-source positioner apparatus 5266 and the reference source 5314 are installed, and then a second counting begins. After a period of counting time (t_{bm,smplFr,nd}), and after a statistically ‘good-enough’ beam-peak count rate (CR_{Ei,bm,smplFr,nd}, 5374) is acquired, the counting is stopped. Subsystem 1630 detects, processes, preserves, and presents the nd and md sample-free beam spectra 5320 and 5370.

If the net reference-source count rates from the two counting positions 5310 and 5360 differ insignificantly, then their associated peak count rates 5324 and 5374 should be equal (CR_{Ei,bm,smplFr,md}=CR_{Ei,bm,smplFr,nd}), in which case, two options are available to the operator; namely, (1) to sum the two count rates to improve the counting statistics, or (2) to count only one sample-container position (either the thick md or thin nd position, but not both) until the desired counting statistics are achieved.

Part 4. “nd: md” Beam-Assisted Detected-Fraction Calibration (FIG. 3).

Before signal detection systems are used to quantify signal-sources in unknown-samples, they usually first require a detection-efficiency calibration of some kind. FIG. 3 illustrates one such system 5400 for calibrating signal detection-efficiency, where a compositionally well-known standard-sample 5414 is filled to a depth (md) in the same type of sample container 5212, and placed in the same position relative to the detector, as were the empty sample containers that were used to acquire the ambient background spectra 5222 and 5272 in FIG. 1 and the sample-free beam spectra 5320 and 5370 in FIG. 2.

Just above the standard-sample container is the same signal-emitting reference-source 5314 as that used to produce the sample-free beam spectra 5320 and 5370 in FIG. 2. The reference-source 5314 acts like a beam-source in the sense that only those signals emitted within the solid angle subtended by the detector, which is part of subsystem 1630, have a chance to pass through the standard-sample 5414 and be detected and registered by subsystem 1630.

Although it is possible to carefully align the reference-source 5314 relative to the standard-sample and detector by many methods, one preferred method is to use a positioner 5216 that assures (1) that the sample container doesn't get contaminated or damaged by the reference-source, and (2) that the reference-source is always positioned in the same spot to achieve reproducible results.

Characteristic signals emanate (dashed lines 5418) from the signal-emitting reference-source 5314 and a fraction of them pass through the sample-container 5212 walls and the standard-sample 5414 contained therein. Those reference-source signals within the solid angle subtended by the detector, act somewhat like a beam penetrating a slab-of-thickness (md) of sample 5414. Some fraction of the beam passes through the standard-sample (stnd) unattenuated (dashed lines 5418), which fraction is called the beam-through-derived (bm), sample-specific beam-transmitted-fraction (BmTrnsF_{Ei,bm,stnd,md}).

Subsystem 1630 acquires at least three spectral components as a single composite gross spectrum for each standard-sample counting; among the spectral components are the ambient background, reference-source beam, and the standard-sample emission. (The gross composite spectrum is not shown in FIG. 3.) To remove the ambient background component, subsystem 1630 normalizes the characteristic ambient background spectra 5222 and 5272 (in FIG. 1) to the standard-sample counting times, and then subtracts-out those normalized ambient background component spectra from the gross composite spectra to produce the net composite spectra 5426 and 5476, which are still comprised of at least two spectral components; namely, the reference-source beam peaks 5424 and 5474, and all the standard-sample spectral peaks (the solid lines in 5426 and 5476).

The nd: md beam-assisted detected-fraction ‘DetF’ calibration software 5500 computes the beam-through-derived, linear attenuation coefficient (μ_{Ei,bm,stnd}) for the composition of the standard-sample by one or more techniques. Three such techniques are described after this description of the system setup 5400. Once the beam-through-derived, characteristic linear attenuation coefficient (μ_{Ei,bm,stnd}) of the standard-sample is determined, software 5500 computes the beam-through-derived, discrete sample-specific escaped-fraction values 5432 and 5482 (identified as the small open circles in FIG. 3), and then computes their associated beam-through-derived, discrete sample-free detected-fraction calibration values 5442 and 5492 (identified as the two small open circles).

Thus, the ratio of the nd and md beam-through-derived, sample-free detected-fraction calibration values is determined, which ratio allows software 5500 to compute standard-sample-derived (stnd), discrete sample-specific escaped-fraction values 5434 and 5484 in graphs 5430 and 5480, respectively, and to compute standard-sample-derived, discrete sample-free detected-fraction calibration values 5444 and 5494 in graphs 5440 and 5490, respectively. The discreet, sample-specific escaped-fraction values are fitted to functions 5436 (dotted line) and 5486 (dotted line) in graphs 5430 and 5480, respectively, and the discrete sample-free detected-fraction values are fitted to functions 5446 (dotted line) and 5496 (dotted line) in graphs 5440 and 5490, respectively. The counting system is now ready to be used to analyze homogeneous unknown-samples.

### nd:md Software Model For Detection-System Calibration (FIG. 4).

FIG. 4 is a flowchart 5500 of the nd: md software model for detection-system calibration. Software module 2010 reads-in nd and md spectral data, standard-sample data, reference-source data, and signal-emitter signal yield-fraction data (YF_{Rj,Ei}).

The data qualification software module 2018 identifies those standard-sample-derived (stnd), characteristic nd and md peak pairs (CR_{Ei,stnd,nd},CR_{Ei,stnd,md}) that are useful for computing associated values of standard-sample-derived, sample-specific beam-transmitted-fraction values (BmTrnsF_{Ei,stnd,nd}, BmTrnsF_{Ei,stnd,md}).

For each characteristic beam-peak pair (or n-tuple of characteristic peaks from n-tuple different sample depths, should three or more standard-sample thicknesses be counted), software module 5520 performs one of three techniques to compute the beam-through-derived (bm),sample-specific beam-transmitted-fraction (BmTrnsF_{Ei,bm,stnd}) and the beam-through-derived, sample-specific linear attenuation (μ_{Ei,bm,stnd}) terms. These techniques are referred to as Technique-1 (5524), Technique-2 (5528), and Technique-3 (5532) in FIG. 4.

Software module 5540 computes the system-specific ratio of the beam-through-derived, sample-free detected-fraction calibration values (RDetF_{Ei,nd:md}) using reference-source beam peaks transmitted through different sample thicknesses.

Technique-1 for Standard-Sample Lin. Atten. Computation (FIG. 5)

FIG. 5 shows that Technique-1 (5524) independently computes the beam-through-derived (bm), sample-specific beam-transmitted-fraction (BmTrnsF_{Ei,bm,stnd}) and beam-through-derived linear attenuation coefficient (μ_{Ei,bm,stnd}) for each of two or more standard-sample thicknesses (e.g. nd and md) and thus, because the linear attenuation coefficient is the same for a given composition of the same density no matter the absolute thickness of the composition, provides independent confirmation of the value for the characteristic linear attenuation coefficient (μ_{Ei,bm,stnd}) for any given homogeneous standard-sample composition.

FIG. 5 shows 5600 the characteristic (BO reference-source 5314 beam-peak (bm) count rates (CR_{Ei,bm,stnd,nd} 5474, CR_{Ei,bm,stnd,md} 5424) through each thickness (nd and md) of standard-sample (stnd) 5414 are compared to their corresponding characteristic sample-free (smplFr) reference-source beam-peak count rates, (CR_{Ei,bm,smplFr,nd} 5374, CR_{Ei,bm,smplFr,md} 5324), to determine the beam-through-derived, standard-sample characteristic linear attenuation coefficient (μ_{Ei,bm,stnd}) for each standard-sample-attenuated and sample-free beam-peak pair. The sample-free md beam-peak (5324 in FIG. 2) count rate (CR_{Ei,bm,smplFr,md}) is paired with the standard-sample-attenuated beam-peak (5424 in FIG. 3) count rate (CR_{Ei,bm,stnd,md}) to make a ‘peak pair 5612’. Similarly, the sample-free nd beam-peak (5374 in FIG. 2) count rate (CR_{Ei,bm,smplFr,nd}) is paired with the standard-sample-attenuated beam-peak (5474 in FIG. 3) count rate (CR_{Ei,bm,stnd,nd}) to make another ‘peak pair 5614’. Thus, the nd and the md peak pairs are

{CR_{Ei,bm,smplFr,nd},CR_{Ei,bm,stnd,nd}} and {CR_{Ei,bm,smplFr,md},CR_{Ei,bm,stnd,md}} [2a]

In principle, the two sample-free beam-peak count rates (CR_{Ei,bm,smplFr,nd} 5374, CR_{Ei,bm,smplFr,nd} 5324) in [2a] should have the same value, i.e. CR_{Ei,bm,smplFr,nd}=CR_{Ei,bm,smplFr,md}, in which case only one sample-free beam-peak counting is needed, and thus, either of the following pairs [2b] or [2c] can be used alone in place of the nd and the md peak pairs described in [2a], so that the use of:

{CR_{Ei,bm,smplFr,nd},CR_{Ei,bm,stnd,nd}} and {CR_{Ei,bm,smplFr,nd},CR_{Ei,bm,stnd,md}} [2b]

is synonymous with

{CR_{Ei,bm,smplFr,md},CR_{Ei,bm,stnd,nd}} and {CR_{Ei,bm,smplFr,md},CR_{Ei,bm,stnd,md}} [2c]

Nevertheless, the following computations use the peak pairs of [2a] while acknowledging that the peak pairs shown in [2b] or [2c] can also be used.

Using the thin (nd) sample-free and standard-sample-attenuated beam-peak pair count rates 5614, i.e. {CR_{Ei,bm,smplFr,nd}, CR_{Ei,bm,stnd,nd}} in Pair [2a], the beam-derived, beam-transmitted-fraction (BmTrnsF_{Ei,bm,stnd,nd} 5622) and linear attenuation coefficient (μ_{Ei,bm,stnd,nd} 5624) of the standard-sample composition 5414 can be computed as follows:

$$\begin{matrix}{BmTrnsF}_{Ei , bm , stnd , nd} = {e}^{- μ \cdot nd} = \frac{{CR}_{Ei , bm , stnd , nd}}{{CR}_{Ei , bm , smplFr , nd}} \\ so that \text{:} & [ 3 a ] \\ {μ}_{Ei , bm , stnd , nd} = \frac{ln ( {BmTrnsF}_{Ei , bm , stnd , nd} )}{- nd} & [ 3 b ]\end{matrix}$$

Using the thick (md) sample-free and standard-sample-attenuated peak-pair count rates 5612, i.e. {CR_{Ei,bm,smplFr,md}, CR_{Ei,bm,stnd,md}} in Pair [2a], the beam-derived, beam-transmitted-fraction (BmTrnsF_{Ei,bm,stnd,md} 5626) and the linear attenuation coefficient (μ_{Ei,bm,stnd,nd} 5628) of the standard-sample composition can be computed as follows:

$$\begin{matrix}{BmTrnsF}_{Ei , bm , stnd , md} = {e}^{- μ \cdot md} = \frac{{CR}_{Ei , bm , stnd , md}}{{CR}_{Ei , bm , smplFr , md}} \\ so that \text{:} & [ 4 a ] \\ {μ}_{Ei , bm , stnd , md} = \frac{ln ( {BmTrnsF}_{Ei , stnd , md} )}{- md} & [ 4 b ]\end{matrix}$$

If peak pairs for two or more standard-sample thicknesses are acquired, then an improvement in the statistics 5632 for the beam-derived, beam-transmitted-fraction through 1 cm of standard-sample (BmTrnsF_{Ei,bm,stnd,1cm} 5634) and for the linear attenuation coefficient (μ_{Ei,bm,stnd,1cm} 5636) can be computed by summing the count rates for each of the individual standard-sample thicknesses, as follows:

CR_{Ei,bm,stnd,nd}30 CR_{Ei,bm,stnd,md}=(CR_{Ei,bm,smplFr,nd})(e^{-μd})+(CR_{Ei,bm,smplFr,md})(e^{-μd})^{m} [5a]

where d is a unit of sample thickness (e.g. d=1 cm). Putting Equation [6a] into standard form yields:

(CR_{Ei,bm,smplFr,nd})(e^{-μd})ⁿ+(CR_{Ei,bm,smplFr,md})(e^{-μd})^{m}−(CR_{Ei,bm,stnd,nd}+CR_{Ei,bm,stnd,md})=0 [5b]

The count rates of the reference-source sample-free beam-peaks through the thick (md) and thin (nd) positions of the sample-free (empty) sample container should be the same. Thus, Equation [5b] is rewritten using the statistically ‘best’ of the two (or more) sample-free beam-peak count rates, which for the purpose of this discussion is the sample-free beam-peak count rate through the thin (nd) counting position, so that Equation [6b] becomes:

$${( {e}^{- μ d} )}^{n} + {( {e}^{- μ d} )}^{m} - ( \frac{{CR}_{Ei , bm , stnd , nd} + {CR}_{Ei , bm , stnd , md}}{{CR}_{Ei , bm , smplFr , nd}} ) = 0 \qquad [ 5 c ]$$

where:

(e^{-μd})=BmTrnsF_{Ei,bm,stnd,1cm} [6a]

which is the transmitted fraction of a characteristic beam through a unit slab of sample thickness d=1 cm, and which is computed numerically by computer.

μ_{Ei,bm,stnd,1cm}=−ln(BmTrnsF_{Ei,bm,stnd,1cm}) [6b]

This method of statistical improvement can be extended to any number of measurements through the standard-sample.

In principle, all determinations of the linear attenuation coefficient for the same homogeneous composition of constant density have the same value, so we define:

μ_{Ei,bm,stnd,nd}=μ_{Ei,bm,stnd,md}=μ_{Ei,bm,stnd,1cm}→μEi,stnd [7]

Technique-2 for Standard-Sample Lin. Atten. Computation (FIG. 5)

FIG. 5 shows that Technique-2 (5328) uses only one standard-sample thickness and its corresponding sample-free beam-peak to compute the beam-through-derived (bm), beam-transmitted-fraction (BmTrnsF_{Ei,bm,stnd}) and linear attenuation coefficient (μ_{Ei,bm,stnd}) for the standard-sample (stnd). Any one of the thicknesses may be chosen, and in the example setups shown in FIGS. 2 and 3, the choices include:

{CR_{Ei,bm,smplFr,nd},CR_{Ei,bm,stnd,nd}} [8a]

or

{CR_{Ei,bm,smplFr,md}),CR_{Ei,bm,stnd,md}} [8b]

From either set of peak pairs, the sample-specific beam-transmitted-fractions (BmTrnsF_{Ei,bm,stnd,nd} and BmTrnsF_{Ei,bm,stnd,md} are computed. As an example, assume that the nd sample-free container position is beamed through (CR_{Ei,bm,smplEr,nd}) and the nd standard-sample depth is beamed through (CR_{Ei,bm,stnd,nd} 5616). In that case, Equation [3a] is used to determine the beam-transmitted-fraction (BmTrnsF_{Ei,bm,stnd,nd} 5642) through the nd standard-sample depth, and Equation [3b] is used to determine the linear attenuation coefficient (μ_{Ei,bm,stnd,nd} 5644) of the standard-sample composition.

Should one want to compute the beam-transmitted fraction through any other thickness of the same standard-sample, then one would use Equation [9], as follows, using the thick (md) standard-sample thickness as an example 5646:

$${BmTrnsF}_{Ei , bm , smpl , md} = {( {BmTrnsF}_{Ei , bm , smpl , nd} )}^{( \frac{m}{n} )} \qquad [ 9 ]$$

Technique-2 for computing the standard-sample linear attenuation coefficient cuts down on the number of countings needed and allows for a longer single pair of sample-free and standard sample countings to improve the counting statistics.

Technique-3 for Standard-Sample Lin. Atten. Computation (FIG. 5)

FIG. 5 shows that Technique-3 (5332) does not use sample-free beam-peak spectra, per se, but rather acquires at least two reference-source beam spectra through at least two different thicknesses of the standard-sample, and, by processing the differences in the beam peaks, one can determine the beam-derived, beam-transmitted-fraction (BmTrnsF_{Ei,bm,stnd,Δd}) and linear attenuation coefficient, (μ_{Ei,bm,stnd}) for the standard-sample (stnd). The beam peak count rate through the thin (nd) sample thickness is taken as the baseline beam peak count rate 5474, whereas the beam peak count rate 5424 through the thick (md) sample thickness is treated as the attenuated beam peak count rate, so that the beam-derived, beam-transmitted-fraction (BmTrnsF_{Ei,bm,stnclAd} 5652) and the linear attenuation (μ_{Ei,bm,stnd,nd} 5654) computations are based on the difference (Δd) between the two sample thicknesses, as follows:

Δd=(md−nd) [11]

and

$$\begin{matrix}{BmTrnsF}_{Ei , bm , stnd , Δ d} = \frac{{CR}_{Ei , bm , stnd , md}}{{CR}_{Ei , bm , stnd , nd}} = {e}^{- μ \cdot Δ d} & [ 12 ] \\ {μ}_{Ei , bm , stnd , Δ d} = \frac{ln ( {BmTrnsF}_{Ei , bm , stnd , Δ d} )}{- Δ d} & [ 13 ]\end{matrix}$$

The beam-derived, beam-transmitted fractions (5656 and 5658), through the nd and md thicknesses, are then computed as:

$$\begin{matrix}{BmTrnsF}_{Ei , bm , smpl , nd} = {( {BmTrnsF}_{Ei , bm , smpl , Δ d} )}^{( \frac{nd}{Δ d} )} \\ and & [ 14 a ] \\ {BmTrnsF}_{Ei , bm , smpl , md} = {( {BmTrnsF}_{Ei , bm , smpl , Δ d} )}^{( \frac{md}{Δ d} )} & [ 14 b ]\end{matrix}$$

The linear attenuation coefficient of the standard-sample composition is always the same through any sample depth, and so we define:

μ_{Ei,stnd,Δd}=μ_{Ei,stnd,nd}=μ_{Ei,stnd,md}→μ_{Ei,stnd} [15]

### Computing the Ratio of nd and md Detected-Fraction Calibs. (FIG. 4)

Now that the beam-through-derived (bm), linear-attenuation coefficient (μ_{Ei,bm,stnd}) for the standard-sample composition at one or more characteristic signal energies is computed by one of the three techniques (5524, 5528, and 5532) just described, the corresponding characteristic beam-through-derived, sample-specific escaped-fraction (EscF_{Ei,bm,stnd}) through any thickness of a standard-sample can easily be computed, e.g.

$$\begin{matrix}{EscF}_{Ei , bm , stnd , nd} = \frac{1}{nd} {\int }_{0}^{nd} ( {e}^{- μ \cdot x} ) d x = \frac{1}{μ \cdot nd} ( 1 - {e}^{- μ \cdot nd} ) & [ 16 a ] \\ {EscF}_{Ei , bm , stnd , md} = \frac{1}{md} {\int }_{0}^{md} ( {e}^{- μ \cdot x} ) d x = \frac{1}{μ \cdot md} ( 1 - {e}^{- μ \cdot md} ) & [ 16 b ]\end{matrix}$$

Equations [16a] and [16b] can be rewritten in terms of the beam-through-derived, beam-transmitted-fraction (BmTrnsF_{Ei,bm,stnd}).

$$\begin{matrix}{EscF}_{Ei , bm , stnd , nd} = \frac{{BmTrnsF}_{Ei , bm , stnd , nd} - 1}{ln ( {BmTrnsF}_{Ei , bm , stnd , nd} )} & [ 17 a ] \\ {EscF}_{Ei , bm , stnd , md} = \frac{{BmTrnsF}_{Ei , bm , stnd , md} - 1}{ln ( {BmTrnsF}_{Ei , bm , stnd , md} )} & [ 17 b ]\end{matrix}$$

The nd and md single characteristic (Eᵢ) beam-through-derived sample-specific escaped-fraction pair (EscF_{Ei,bm,stnd,nd}, ESCF_{Ei,bm,stnd,md}) are shown as the open circles 5432 and 5482 in FIG. 3. Spectra 5426 and 5476 in FIG. 3 each show only one reference-beam characteristic peak (5424 and 5474) to which the corresponding nd and sample-free escaped-fraction values are computed for the standard-sample. To solve for the beam-through-derived (bm), sample-free detected-fraction calibration terms (DetF_{Ei,bm,smplFr,nd}; DetF_{Ei,bm,smplFr,md}) for the two (or more) spectrally measured thicknesses of the same homogeneous standard-sample, the two count rate balance Equations [18a] and [18b] are defined and then rearranged to solve for the beam-through-derived, sample-free detected-fraction terms, as follows:

CR_{Ei,bm,stnd,nd}=M_{stnd}*SpA_{Rj,stnd}*YF_{Rj,Ei}*EscF_{Ei,bm,stnd,nd}*DetF_{Ei,smplFr,nd} [18a]

CR_{Ei,bm,stnd,md}=M_{stnd}*SpA_{Rj,stnd}*YF_{Rj,Ei}*EscF_{Ei,bm,stnd,md}*DetF_{Ei,bm,smplFr,md} [18b]

where the known mass of the spectrally measured standard-sample is given by (M_{stnd}); the known signal emitters (Rⱼ) and their specific-activity quantities are given by (SpA_{Rj,stnd}); the known published signal-emitter characteristic (Eᵢ) emission yield-fractions are given by (YF_{Rj,Ei}); the two computed beam-through-derived, sample-specific escaped-fraction terms are given by (EscF_{Ei,bm,stnd,nd}, ESCF_{Ei,bm,stnd,md}); the two computed beam-through-derived, sample-free detected-fraction calibration terms are given by (DetF_{Ei,bm,smplFr,nd}; DetF_{Ei,bm,smplFr,md}); and the known measured beam count rate terms are given by (CR_{Ei,bm,stnd,nd} and CR_{Ei,bm,stnd,md}). Rearranging the two count rate balance Equations [18a] and [18b] to solve for the beam-through-derived (bm), sample-free detected-fraction calibration terms yield:

$$\begin{matrix}{DetF}_{Ei , bm , smplFr , nd} = \frac{{CR}_{Ei , bm , stnd , nd}}{{M}_{stnd} * {SpA}_{Rj , stnd} * {YF}_{Rj , Ei} * {EscF}_{Ei , bm , stnd , nd}} & [ 19 a ] \\ {DetF}_{Ei , bm , smplFr , md} = \frac{{CR}_{Ei , bm , stnd , md}}{{M}_{stnd} * {SpA}_{Rj , stnd} * {YF}_{Rj , Ei} * {EscF}_{Ei , bm , stnd , md}} & [ 19 b ]\end{matrix}$$

The ratio of the sample-free detected-fraction calibration terms at this particular characteristic beam energy (RDetF_{Ei,bm,nd:md}) is then computed from:

$${RDetF}_{Ei , bm , nd : md} = \frac{{DetF}_{Ei , bm , smplFr , nd}}{{DetF}_{Ei , bm , smplFr , md}} \qquad [ 20 a ]$$

The sample-free detected-fraction calibration terms are comprised of two terms, the geometry-fraction (GF) and the capture-fraction (CapF_{Ei}). These two terms are disclosed and discussed in detail in the related U.S. patent application Ser. No. 13/049,903. Both terms are independent of the standard-sample composition. Over the energy-range of interest, GF remains constant for a given standard-sample placement orientation with respect to the detection system. Over the energy-range of interest, Cap F_{Ei} will vary in proportion to signal attenuation through the detection system materials as a function of characteristic signal energy (Eᵢ). In many sample-detector setups, CapF_{Ei} varies with energy (Eᵢ) in approximately the same proportion for both the nd and md standard-sample orientations. Consequently, the ratio of the nd and md sample-free detected-fraction calibration terms, computed at any given characteristic energy (Eᵢ), should remain relatively constant over the entire energy range of the spectrum. This can be confirmed by using a multi-energy beam source.

RDetF_{Ei,bm,nd:md}→RDetF_{nd:md}≈Constant for Eᵢε{low,high} [20b]

So far, the beam-through-derived, sample-specific escaped-fraction terms (EsCF_{Ei,bm,stnd,nd}, ESCF_{Ei,bm,stnd,md}) and the beam-through-derived, sample-free detected-fraction calibration terms (DetF_{Ei,bm,smplFr,nd}, DetF_{Ei,bm,smplFr,md}) have only been determined for a single beam energy (Eᵢ) which is shown as the tall peak 5424 in the spectrum 5426, and the tall peak 5474 in the spectrum 5476, of FIG. 3.

Software module 5550 uses all of the ‘useful’ standard-sample-derived peak pairs (or n-tuple of characteristic peaks from n-tuple different sample thicknesses should three or more thicknesses of the standard-samples be counted), where ‘useful’ peak pairs are determined by software model 2018 in FIG. 4, to compute the standard-sample-derived (stnd), characteristic linear attenuation coefficients (μ_{Ei,stnd}) and the standard-sample-derived, sample-specific beam-transmitted-fraction (BmTrnsF_{Ei,stnd,nd}; BmTrnsF_{Ei,stnd,md) of the standard-sample.}

This is a multi-step process accomplished by first taking the ratio of the two count-rate balance Equations [21a] and [21b] that correspond to each characteristic standard-sample-derived peak pair, (CR_{Ei,stnd,nd}; CR_{Ei,stnd,md}); as follows:

CR_{Ei,stnd,nd}=M_{stnd}*SpA_{Rj,stnd}*YF_{Rj,Ei}*ESCF_{Ei,stnd,nd}*DetF_{Ei,smplFr,nd} [21a]

CR_{Ei,stnd,md}=M_{stnd}*SpA_{Rj,stnd}*YF_{Rj,Ei}*ESCF_{Ei,stnd,md}*DetF_{Ei,smplFr,nd} [21b]

and taking their ratio yields:

$$\frac{{CR}_{Ei , stnd , nd}}{{CR}_{Ei , stnd , md}} = \frac{{M}_{stnd} * {SpA}_{Rj , stnd} * {YF}_{Rj , Ei} * {EscF}_{Ei , stnd , nd} * {DetF}_{Ei , smplFr , nd}}{{M}_{stnd} * {SpA}_{Rj , stnd} * {YF}_{Rj , Ei} * {EscF}_{Ei , stnd , md} * {DetF}_{Ei , smplFr , md}} \qquad [ 22 a ]$$

Equation [22a] is one equation in four unknowns. The four unknowns are the two standard-sample-derived, sample-specific escaped-fraction terms (EscF_{Ei,stnd,nd} and EscF_{Ei,stnd,md}); and the two standard-sample-derived, sample-free detected-fraction calibration terms (DetF_{Ei,smplFr,nd} and DetF_{Ei,smplFr,md}). The known terms are the measured nd and standard-sample-derived count rates (CR_{Ei,stnd,nd} and CR_{Ei,stnd,md}); the measured standard-sample mass (M_{stnd}); the reported signal emitters (Rⱼ) and their specific-activity quantity (SpA_{Rj,stnd}); and the widely published signal-emitter characteristic (Eᵢ) emission yield-fractions (YF_{Rj,Ei}). Then, cancelling the equal terms and substituting for known ratios of like terms, reduces the number of unknowns in Equation [22a] to only two unknowns in Equation [22b]; i.e. the two sample-specific escaped-fraction terms (EscF_{Ei,stnd,nd} and ESCF_{Ei,stnd,md});

$$\frac{{CR}_{Ei , stnd , nd}}{{CR}_{Ei , stnd , md}} = \frac{{EscF}_{Ei , stnd , nd}}{{EscF}_{Ei , stnd , md}} * {RDetF}_{nd : md} \qquad [ 22 b ]$$

where the ratio of the sample-free detected-fraction calibration terms (DetF_{Ei,smplFr,nd}; DetF_{Ei,smplFr,md}) are replaced by the ratio factor RDetF_{nd:md}.

In many cases, the ratio of the two sample-free detected-fraction calibration terms (RDetF_{nd:md}) is very close to unity for the detection-system/sample-volume-shape and position setup shown in FIG. 3.

To solve Equation [22b], the two sample-specific escaped-fraction terms are defined in terms of the fraction of a characteristic beam that transmits through a standard-sample whose “per unit” thickness is one centimeter (d=1 cm). In a preliminary step, the two unknown terms in Equation [22b] (ESCF_{Ei,stnd,nd}, EscF_{Ei,stnd,md}) are redefined using a single new common term, i.e. the characteristic sample-specific linear attenuation coefficient (μ_{Ei,stnd}).

The thick (md) and thin (nd) standard-sample orientations yield characteristic sample-specific escaped-fraction terms according to:

$$\begin{matrix}{EscF}_{Ei , stnd , nd} = \frac{1}{nd} {\int }_{0}^{nd} {e}^{- μ \cdot x} d x = \frac{1}{μ \cdot nd} ( 1 - {e}^{- μ \cdot nd} ) & [ 23 a ] \\ {EscF}_{Ei , stnd , md} = \frac{1}{md} {\int }_{0}^{md} {e}^{- μ \cdot x} d x = \frac{1}{μ \cdot md} ( 1 - {e}^{- μ \cdot md} ) & [ 23 b ]\end{matrix}$$

Knowing that a beam passing through each of the sample depths (nd and md) attenuates according to:

BmTrnsF_{Ei,stnd,nd}=e^{-μ·nd}=(e^{-μd})ⁿ=(BmTrnsF_{Ei,stnd,1cm})ⁿ [24a]

BmTrnsF_{Ei,stnd,md}=e^{-μ·md}=(e^{-μd})^{m}=(BmTrnsF_{Ei,stnd,1cm})^{m} [24b]

and where d=1 cm; the linear attenuation per centimeter of thickness (cm⁻¹) of the standard-sample composition is:

μ_{Ei,stnd}=−ln(BmTrnsF_{Ei,stnd,1cm}) [25]

Then, rewriting Equations [23a] and [23b] in terms of a beam passing through 1 cm of standard sample composition, BmTrnsF EscF_{Ei,stnd,1cm} yields:

$$\begin{matrix}{EscF}_{Ei , stnd , nd} = \frac{{( {BmTrnsF}_{Ei , stnd , 1 c m} )}^{n} - 1}{n * ln ( {BmTrnsF}_{Ei , stnd , 1 c m} )} & [ 26 a ] \\ {EscF}_{Ei , stnd , md} = \frac{{( {BmTrnsF}_{Ei , stnd , 1 c m} )}^{m} - 1}{m * ln ( {BmTrnsF}_{Ei , stnd , 1 c m} )} & [ 26 b ]\end{matrix}$$

Substituting the expressions of Equations [26a] and [26b] into Equation [22b], and reducing terms, yields:

$$\begin{matrix}\frac{{CR}_{Ei , stnd , nd}}{{CR}_{Ei , stnd , md}} = [ \frac{m}{n} * \frac{{( {BmTrnsF}_{Ei , stnd , 1 c m} )}^{n} - 1}{{( {BmTrnsF}_{Ei , stnd , 1 c m} )}^{m} - 1} ] * {RDetF}_{nd : md} \\ which rearrages to \text{:} & [ 27 a ] \\ [ \frac{{CR}_{Ei , stnd , nd}}{{CR}_{Ei , stnd , md}} ] {( {BmTrnsF}_{Ei , stnd , 1 c m} )}^{m} - [ \frac{m}{n} ] ( {RDetF}_{nd : md} ) {( {BmTrnsF}_{Ei , stnd , 1 c m} )}^{n} + [ \begin{matrix}( \frac{m}{n} * {RDetF}_{nd : md} ) - \\ ( \frac{{CR}_{Ei , stnd , nd}}{{CR}_{Ei , stnd , md}} )\end{matrix} ] = 0 & [ 27 b ]\end{matrix}$$

The only unknown in Equation [27b] is the beam-transmitted-fraction through 1 cm of standard-sample depth (BmTrnsF_{Ei,stnd,1cm}), which is easily solved numerically by computer.

Although not required to be known to quantify the radioisotopes of interest, nevertheless, there may be an interest to knowing the standard-sample energy-specific linear attenuation (μEi,stnd). Once the value of BmTrnsF_{Ei,stnd,1cm} is known from Equation [27b], Equation [25] is used to determine the value of the linear attenuation coefficient (μ_{Ei,stnd}) for the standard-sample composition.

Software module 5560 calls the count rates of the characteristic peak pairs and the corresponding characteristic values of BmTrnsF_{Ei,stnd,1cm}, and computes the associated sample-specific escaped-fraction values (EscF_{Ei,stnd,nd}, EsCF_{Ei,stnd,md}) using Equations [26a] and [26b], as well as provides for computing sample-specific escaped-fraction functions or interpolated curves to cover the entire energy range, i.e.

ESCF_{Ei,stnd,nd}→EscF(Eᵢ)_{stnd,nd} [28a]

ESCF_{Ei,stnd,md}→EscF(Eᵢ)_{stnd,md} [28b]

and computes their associated uncertainties.

Software module 2040 in FIG. 4 evaluates and processes the ‘useful’ discrete, sample-specific escaped-fraction values and uncertainties for computing sample-specific escaped-fraction functions or interpolated curves.

Software module 2058 computes the sample-free detected-fraction calibration terms (DetF_{Ei,smplFr,nd} and DetF_{Ei,smplFr,md}) using Equations [29a] and [29b], as follows:

$$\begin{matrix}{DetF}_{Ei , smplFr , nd} = \frac{{CR}_{Ei , stnd , nd}}{{M}_{stnd} * {SpA}_{Rj , stnd} * {YR}_{Rj , Ei} * {EscF ( {E}_{i} )}_{stnd , nd}} & [ 29 a ] \\ {DetF}_{Ei , smplFr , md} = \frac{{CR}_{Ei , stnd , md}}{{M}_{stnd} * {SpA}_{Rj , stnd} * {YF}_{Rj , Ei} * {EscF ( {E}_{i} )}_{stnd , md}} & [ 29 b ]\end{matrix}$$

Software module 2058 also computes the associated uncertainties, indicates which of Equations [29a] and [29b] provides the better statistics for the sample-free detected-fraction calibration and provides for computing sample-free detected-fraction calibration functions or interpolated curves to cover the entire energy range, i.e.

DetF_{Ei,smplFr,nd}→DetF(Eᵢ)_{smplFr,nd} [30a]

DetF_{Ei,smplFr,md}→DetF(Eᵢ)_{smplFr,md} [30b]

and formats all the data from each part of the software flow, as just described, for presentation by spreadsheet, comma separated value (CSV) listings, and computer screen presentation.

The mathematical laws of error analysis are computed as appropriate alongside the mathematical operations on the values of the terms comprising the count rate balance equations. Thus, the terms will have the form ν±Δν, where ν represents the numerical value of a particular term and ±Δν is the uncertainty in ν.

Once calibrated, the counting system is ready to identify, measure, and compute quantities of signal emitters in unknown-samples.

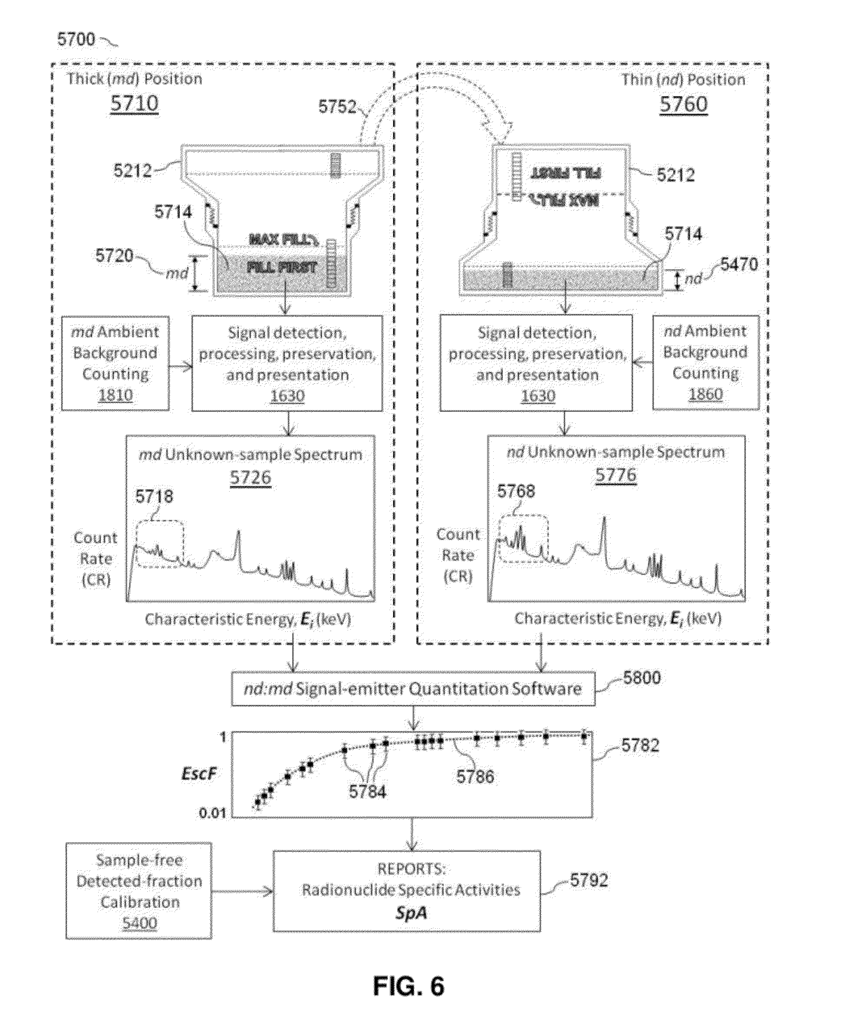

Part 5. “nd: md” Signal-Emitter Quantitation (FIG. 6)

To quantify the individual signal emitter of each characteristic signal (Eᵢ) in unknown-samples (unkn) of homogeneous composition, the values of the sample-specific escaped-fraction (EscF_{Ei,unkn}) are computed and combined with the computed values for the sample-free detected-fraction calibration (DetF_{Ei,smplFr}), y quantities which then results in signal emitter (Rⱼ) specific-activity (SpA_{Rj,unkn}). FIG. 6 illustrates one such system 5700 for analyzing homogeneous samples of unknown signal-emitter specific-activity quantities (SpA_{Rj,unkn}).

It is presumed that the sample-free detected-fraction calibration (DetF_{Ei,smplFr}) has been performed, after which the unknown-sample is placed in the same type of sample-container apparatus, and in the same position and orientation relative to the detection system, as the sample-container apparatuses (disclosed in detail in FIG. 18 of the related U.S. patent application Ser. No. 13/049,903) that were used to acquire the ambient background emission spectra and the standard-sample emission spectra (the solid spectral lines in graphs 5426 and 5476 of FIG. 3).

An unknown-sample mass (Mᵤₙₖₙ), may be computed where the mass of an empty sample-container apparatus (M_{cntr}) is subtracted from the combined mass of the sample-container apparatus and the unknown-sample (M_{cntr+unkn}), as follows:

Mᵤₙₖₙ=M_{cntr+unkn}−M_{cntr} [31]

It is presumed for this particular discussion that the unknown-sample 5714 is first placed into the md cup 5720 of the cylindrical nd: md sample-container apparatus 5212. (Note: in the alternative, the operator could have placed the unknown-sample into the nd cup 5470 instead and proceeded accordingly.) Then the sample-container apparatus is sealed securely and placed into the thick (md) position 5710 for counting, and counting then commences. Characteristic signals (Eᵢ) that escape the thick (md) unknown-sample 5714 and register, along with the ambient background signals, in the signal detection, processing, preservation, and presentation subsystem 1630, produce a “thick” gross composite spectrum (not shown).

Once the “thick” gross composite spectrum is obtained, then the sample-container apparatus 5212 is flipped 180 degrees 5752 into the thin (nd) position 5760 which ‘reshapes’ the unknown-sample 5714 to fill the wider-diameter cylinder of thinner depth (nd) 5470. Characteristic signals (Eᵢ) that escape the thin (nd) unknown-sample and register, along with the ambient background signals, in subsystem 1630, produce a “thin” gross composite spectrum (not shown).

Count rates can be compared directly. The ambient background signal count rates 1810 and 1860 are subtracted-out from their corresponding “thick” and “thin” unknown-sample gross spectra (not shown) leaving the corresponding net unknown-sample spectra 5726 and 5776. This can be summarized, as follows:

CR_{Ei,unkn,nd}=GCR_{Et,unkn,nd}−BCR_{Ei,nd} [32a]

CR_{Ei,unkn,md}=GCR_{Ei,unkn,md}−BCR_{Ei,md} [32b]

By comparing the nd and md net unknown-sample spectra 5726 and 5776, there is a noticeable, significant difference between the peak heights at the low-energy portion of both the thick (md) and thin (nd) net unknown-sample spectra 5718 and 5768. The highly attenuated peaks of the thick (md) unknown-sample counting 5710 are anticipated because, at low energy, more of the characteristic signals (Eᵢ) are attenuated within the thick ‘shape’ of the unknown-sample, relative to its thin ‘shape’.

FIG. 5 also shows the nd:md Signal-emitter Quantitation Software 5800 that reads input of the ‘thick’ and ‘thin’ spectral peak data and computes, for each useful thick and thin characteristic spectral-peak pair, the discrete characteristic sample-specific escaped-fraction values (EscF_{Ei,unkn,nd} and EscF_{Ei,unkn,md}, of which only one set of discrete values is shown 5784); interpolated or fitted sample-specific escaped-fraction functions [EscF(Eᵢ)_{unkn,nd} and EscF(Eᵢ)_{unkn,md}, of which only one function is shown as the dotted line 5786]; and signal-emitter identities (Rⱼ) and corresponding specific-activity quantities (SpA_{Rj,unkn}) 5792.

All of the discrete characteristic sample-specific escaped-fraction values 5784, taken together, resemble the outline of a curve that spans the energy range of interest (represented by the dotted line 5786). Commonly, a function is fitted to these discrete values 5784 to cover the entire usable energy-detection range of the detection system. The discrete values 5784 and all of the possible fitted values 5786 of the sample-specific escaped fraction are illustrated together in graph 5782.

The specific-activity quantities (SpA_{Rj,unkn}) within the unknown-sample 5714 are computed by software 5800, where the software 5500 (in FIG. 4) computes the fitted sample-free detected-fraction calibration functions [DetF(Eᵢ)_{smplFr,nd}, DetF(Eᵢ)_{smplFr,md}].

Subsystem 5792 aggregates all of the processed data into user-selected or default formats, e.g. comma-separated-value (CSV) list, spreadsheet, computer screen, or other suitable output format.

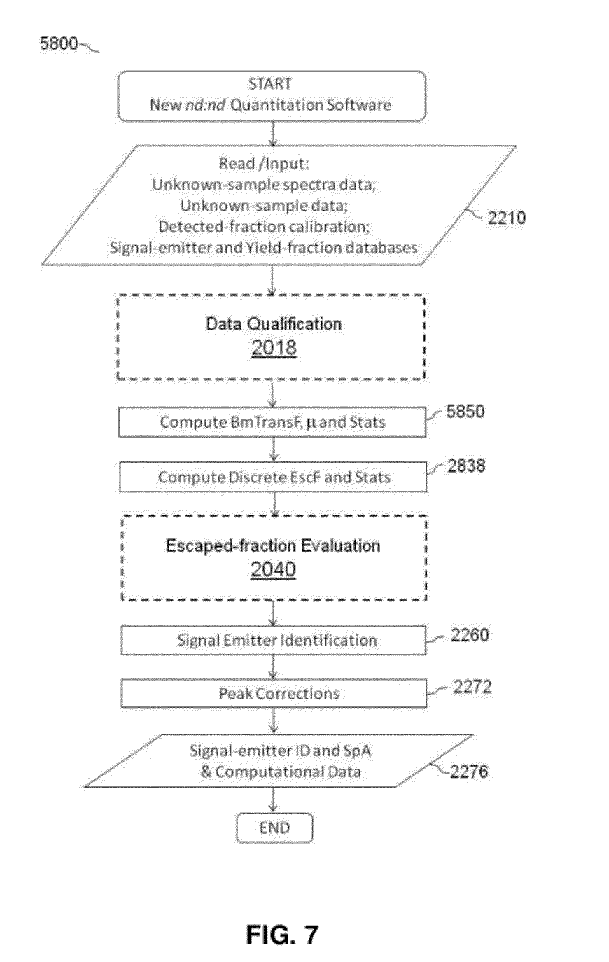

### nd:md Software Model for Signal-Emitter Quantitation (FIG. 7)

FIG. 7 shows the flowchart 5800 of the new nd:md sample-analysis software. Software module 2210 reads-in (a) the primary unknown-sample nd and md spectral data, which includes the nd and md characteristic-peak net count rates (CR_{Ei,unkn,nd}, CR_{Ei,unkn,md}); (b) unknown-sample data, such as the unknown-sample mass (Mᵤₙₖₙ); (c) the interpolated or fitted sample-free detected-fraction calibration functions [DetF(Eᵢ)_{smplFr,nd}, DetF(Eᵢ)_{smplFr,md}]; and (d) signal-emitter (Rⱼ) and yield-fraction (YF_{Rj,Ei}) databases. The Data Qualification software module 2018 in FIG. 7 identifies those characteristic nd and md peak pairs that are ‘useful’ for computing the associated sample-specific beam-transmitted-fraction values (BmTrnsF_{Ei,unkn,nd}, BmTrnsF_{Ei,unkn,md}).

For each characteristic-peak pair, software module 5850 calls the values of the peak pairs and computes the sample-specific beam-transmitted-fraction values (BmTrnsF_{Ei,unkn,nd}; BmTrnsF_{Ei,unkn,md}) and the sample-specific linear attenuation coefficient (μ_{Ei,unkn}). The count rates for each characteristic-peak pair (or n-tuple of characteristic peaks from n-tuple different sample thicknesses, should three or more be counted) and other related terms, are shown in the count-rate balance equations as follows:

CR_{Ei,unkn,nd}=Mᵤₙₖₙ*SpA_{Rj,unkn}*YF_{Rj,Ei}*EscF_{Ei,unkn,nd}*DetF(Eᵢ)_{smplFr,nd} [33a]

CR_{Ei,unkn,md}=Mᵤₙₖₙ*SpA_{Rj,unkn}*YF_{Rj,Ei}*EscF_{Ei,unkn,md}*DetF(Eᵢ)_{smplFr,md} [33b]

Equations [33a] and [33b] are two equations in four unknowns. The four unknowns are the two sample-specific escaped-fraction terms (EscF_{Ei,unkn,nd}, ESCF_{Ei,unkn,md}); signal-emitter identities (Rⱼ) and their specific-activity quantities (SpA_{Rj,unkn}); and the associated signal-emitter characteristic (Eᵢ) emission yield-fractions (YF_{Rj,Ei}). The known terms are the measured nd and md count rates (CR_{Ei,unkn,nd}, CR_{Ei,unkn,md}); the measured unknown-sample mass (Mᵤₙₖₙ); and the two sample free detected-fraction calibration terms [DetF(Eᵢ)_{smplFr,nd}, DetF(Eᵢ)_{smplFr,md}]. To reduce the number of unknowns, the approach is to take the ratio of the nd and md count-rate balance Equations [33a] and [33b], as follows:

$$\frac{{CR}_{Ei , unkn , nd}}{{CR}_{Ei , unkn , md}} = \frac{\begin{matrix}{M}_{stnd} * {SpA}_{Rj , unkn} * {YF}_{Rj , Ei} * \\ {EscF}_{Ei , unkn , nd} * {DetF ( {E}_{i} )}_{smplFr , nd}\end{matrix}}{\begin{matrix}{M}_{stnd} * {SpA}_{Rj , unkn} * {YF}_{Rj , Ei} * \\ {EscF}_{Ei , unkn , md} * {DetF ( {E}_{i} )}_{smplFr , md}\end{matrix}} \qquad [ 34 a ]$$

Cancelling the equal terms in Equation [34a] and substituting for the known ratio of the two sample-free detected-fraction calibration terms, leaves one Equation [34b] in two unknowns,

$$\frac{{CR}_{Ei , unkn , nd}}{{CR}_{Ei , unkn , md}} = \frac{{EscF}_{Ei , unkn , nd}}{{EscF}_{Ei , unkn , md}} * {RDetF}_{nd ; md} \qquad [ 34 b ]$$

where the ratio of the two terms, [DetF (Eᵢ)_{smplFr,nd}, DetF(Eᵢ)_{smplFr,md}] is replaced by a single term, RDetF_{nd:md}, whose value was computed in the detection-system calibration Equations [20a] and [20b]. In many cases, such value of this term (RDetF_{nd:md}), is very close to unity for the system setup shown as in FIG. 3.

Rewriting the sample-specific escaped-fraction terms, (EscF_{Ei,unkn,nd}, EscF_{Ei,unkn,md}) in terms of a beam through one centimeter of unknown-sample composition (BmTrnsF_{Ei,unkn,1cm}) yields:

$$\begin{matrix}{EscF}_{Ei , unkn , nd} = \frac{{( {BmTrnsF}_{Ei , unkn , 1 c m} )}^{n} - 1}{n \cdot ln ( {BmTrnsF}_{Ei , unkn , 1 c m} )} & [ 35 a ] \\ {EscF}_{Ei , unkn , md} = \frac{{( {BmTrnsF}_{Ei , unkn , 1 c m} )}^{m} - 1}{m \cdot ln ( {BmTrnsF}_{Ei , unkn , 1 c m} )} & [ 35 b ]\end{matrix}$$

Replacing these sample-specific escaped-fraction terms of Equation [34b] with their equivalent expressions from Equations [35a] and [35b] yields:

$$\frac{{CR}_{Ei , unkn , nd}}{{CR}_{Ei , unkn , md}} = [ \frac{m}{n} * \frac{{( {BmTrnsF}_{Ei , unkn , 1 c m} )}^{n} - 1}{{( {BmTrnsF}_{Ei , unkn , 1 c m} )}^{m} - 1} ] * {RDetF}_{nd : md} \qquad [ 36 a ]$$

which rearranges to:

$$[ \frac{{CR}_{Ei , unkn , nd}}{{CR}_{Ei , unkn , md}} ] {( {BmTrnsF}_{Ei , unkn , 1 c m} )}^{m} - [ \frac{m}{n} ] ( {RDetF}_{nd : md} ) {( {BmTrnsF}_{Ei , unkn , 1 c m } )}^{n} + [ \begin{matrix}( \frac{m}{n} * {RDetF}_{nd : md} ) - \\ ( \frac{{CR}_{Ei , unkn , nd}}{{CR}_{Ei , unkn , md}} )\end{matrix} ] = 0 \qquad [ 36 b ]$$

The only unknown in Equation [36b] is the beam-transmitted-fraction through a unit (1-cm) of unknown-sample thickness (BmTrnsF_{Ei,unkn,1cm}), which is easily solved numerically by a computer. Although not required to be known to quantify the signal-emitters of interest, nevertheless there may be an interest to know the unknown-sample energy-specific linear attenuation coefficient (μ_{Ei,unkn}). Once the value of BmTrnsF_{Ei,unkn,1cm} is known from Equation [36b], then Equation [36c] is used to compute the value of the linear attenuation coefficient (μ_{Ei,unkn}) for the unknown-sample. The characteristic linear attenuation per centimeter of thickness (1 cm) of the unknown-sample is:

μ_{Ei,unkn}=−ln(BmTrnsF_{Ei,unkn,1cm}) [36c]

Software module 2838 in FIG. 7 performs a number of functions. It calls the count rates of the characteristic-peak pairs and the corresponding characteristic values of BmTrnsF_{Ei,unkn,1cm}; computes the associated sample-specific escaped-fraction values (EscF_{Ei,unkn,nd}, ESCF_{Ei,unkn,md}) using Equations [35a] and [35b]; and then provides for computing sample-specific escaped-fraction functions or interpolated curves to cover the entire energy region of interest:

ESCF_{Ei,unkn,nd}→EscF(Eᵢ)_{unkn,nd} [37a]

ESCF_{Ei,unkn,md}→EscF(Eᵢ)_{unkn,md} [37b]

and computes their associated statistics.

Software module 2040 in FIG. 7 evaluates and processes the ‘useful’ discrete sample-specific escaped-fraction values 5784 in FIG. 6 and its associated statistics to compute a sample-specific escaped-fraction function or interpolated curve 5786. Only one set of values for discrete sample-specific escaped-fraction values 5782 is illustrated in FIG. 6 (either EscF_{Ei,unkn,nd} or ESCF_{Ei,unkn,md}), because only one of Equations [38a] and [38b] is necessary to determine the signal-emitter quantities (SpA_{Rj,unkn}). The logical choice is the one that provides the best statistics for SpA_{Rj,unkn}.

$$\begin{matrix}{SpA}_{Rj , unkn} = \frac{{CR}_{Ei , unkn , nd}}{{M}_{unkn} * {YF}_{Rj , Ei} * {EscF ( {E}_{i} )}_{unkn , nd} * {DetF ( {E}_{i} )}_{smplFr , nd}} & [ 38 a ] \\ {SpA}_{Rj , unkn} = \frac{{CR}_{Ei , unkn , md}}{{M}_{unkn} * {YF}_{Rj , Ei} * {EscF ( {E}_{i} )}_{unkn , md} * {DetF ( {E}_{i} )}_{smplFr , md}} & [ 38 b ]\end{matrix}$$

Software module 2260 in FIG. 7 searches databases for known signal emitters (Rⱼ) and their characteristic (Eᵢ) yield-fractions (YF_{Rj,Ei}) that match the spectral peaks arising from unknown-samples. Then, spectral analysis is performed, and the signal-emitters (Rⱼ) and their associated yield-fractions (YF_{Rj,Ei}) are identified.

Software module 2272 computes the specific-activity quantities (SpA_{Rj,unkn}) of the identified signal-emitters and their associated statistics. The interpolated or fitted sample-specific escaped-fraction functions, [EscF(Eᵢ)_{unkn,nd}, EscF(Eᵢ)_{unkn,md}], are used in place of the discrete-value terms (ESCF_{Ei,unkn,nd}, ESCF_{Ei,unkn,nd}), except that, in some cases, the operator may use the discrete sample-specific escaped-fraction values. Software module 2272 also identifies which of Equations [38a] or [38b] provides the better statistics for the computed specific-activity values.

Software module 2276 formats all of the data from each part of the process flow, as just described, for presentation by e.g. spreadsheets, comma-separated-value (CSV) lists, and computer screen presentations.

The mathematical laws of error analysis are used to compute the statistics for the values associated with each of the terms comprising the count rate balance Equations [33a] and [33b]. Thus, the terms will have the form ν±Δν, where ν represents the numerical value of a particular term in Equations [33a] and [33b], and +Δν is the uncertainty in ν.

The statistics of the specific-activity quantitation (SpA_{Rj,unkn}) can be improved by applying the ‘sum and difference’ method (described in the related U.S. patent application Ser. No. 13/049,903) to two or more different-thickness count rates from the unknown-sample (e.g. CR_{Ei,unkn,nd} and CR_{Ei,unkn,md}), and by incorporating the new term for the ratio of the reference-beam-derived sample-free detected-fraction calibration (RDetF_{nd:md}) into the ‘sum-and-difference’ formulas.

II. “nd: md” Beam-Assisted Multiple-Mass Sample Analysis

In prior disclosures (described in the related U.S. patent application Ser. No. 13/049,903), a homogeneous sample is ‘shaped’ into at least two different thicknesses within a single sample-container, with respect to one or more detectors. If only one detector is present, the detector (or the sample-container) is repositioned to change the effective thickness of the sample in the direction of the detector. This section discloses new apparatuses and methods that allow for the use of the sample container and detector to be maintained in their same position during a series of multiple countings, but that, for at least two countings, the mass (and hence, the ‘thickness’ of the sample in the direction of the detector) is different, i.e. by adding into, or subtracting from, the already-counted sample mass in the sample-container, in order to perform an additional counting with the new quantity of sample mass. Alternatively, two or more samples of differing mass but the same homogeneous composition can be counted using two or more sample-containers of the same shape, size, and type. Each of such containers is placed into the same position with respect to the detector during each of such individual countings.

Because the sample-containers that are used to count multiple masses of the same standard-sample composition, are the same in every meaningful respect, then only two ambient background countings—one of an empty sample-container with, and one without, an empty reference-beam positioner—need to be performed in order to improve the statistics of the detection-system signal-detection efficiency calibration. For the same reason, only one sample-free reference-beam counting is needed. All three of these ‘parts’ are performed as taught previously. The teaching in this disclosure begins with a fourth part (Part 4).

Part 1. “nd: md” Ambient Background Emission Spectrum Acquisition

The Part-1 system setup, i.e. ambient background emission spectrum acquisition, is disclosed in the related disclosure (Appl. No. 13049903) and will not be taught again here.

Part 2. “nd: md” Ambient Background With Auxiliary Apparatus (FIG. 1)

The Part-2 system setup, i.e. “nd: md” Ambient Background with Auxiliary Apparatus (FIG. 1) is taught earlier in this disclosure and will not be taught again here.

Part 3. “nd: md” Sample-Free Ref-Source Emission Spectrum (FIG. 2)

The Part-2 system setup, i.e. “nd: md” Sample-Free Ref-Source Emission Spectrum (FIG. 2) acquisition is taught earlier in this disclosure and will not be taught again here.

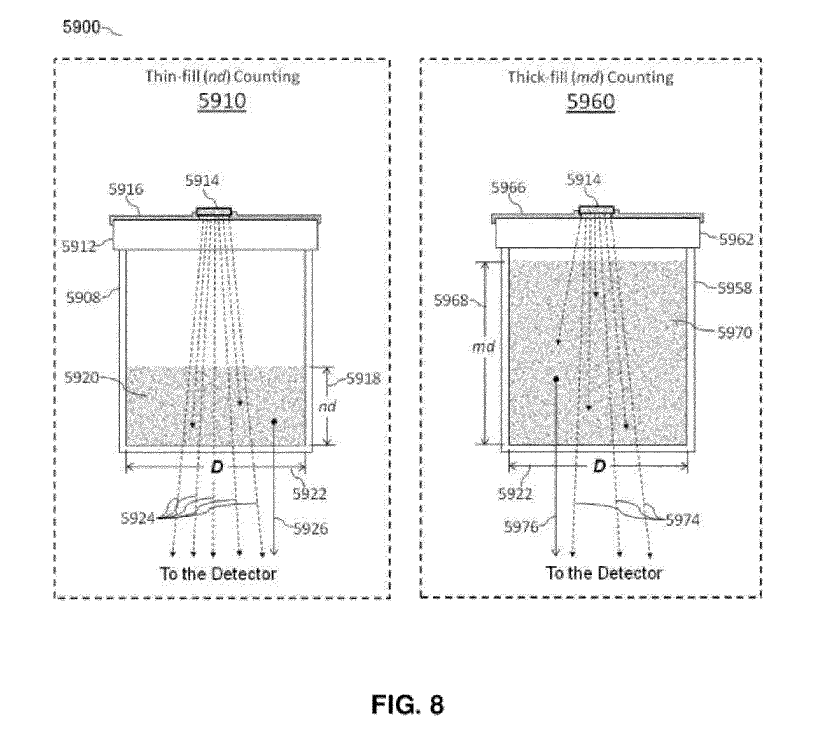

Part 4. “nd: md” Beam-Assisted Multiple-Mass Calibration (FIG. 8)

Before signal detection systems can be used to quantify signal-sources in unknown-samples, they usually first require a signal detection-efficiency calibration of some kind. FIG. 8 illustrates one such system 5900 for calibrating signal detection-efficiency, where a compositionally well known standard-sample 5916 is filled to a ‘thin’ (nd) 5918 thickness (or depth) relative to the thickness of other standard-samples of the same composition in the same type of sample-container; and placed in the same position relative to the detector, as were the empty sample-containers that were used to acquire the ambient background spectra and sample-free beam spectrum.

Just above the sample-container that holds the standard-sample is the same signal-emitting reference-source 5914 as that used to produce the sample-free beam spectrum (not shown). The reference-source acts like a beam-source in that only those signals 5924 emitted within the solid angle subtended by the detector are countable.

Although it is possible to carefully align the reference-source with respect to the standard-sample and detector by many methods, one preferred method is to use a reference-source positioner 5816 that ensures (1) that the sample-containers 5912 and 5962 do not become contaminated or damaged by the reference-source 5914, and (2) that the reference source is always positioned in the same location with respect to the detector, in order to achieve repeatable results.

Characteristic signals emanate (dashed lines 5924 and 5974) from the signal-emitting reference-source 5914 and a fraction of them pass through the sample-container walls 5908 and 5958; sample-container cap 5912 and 5962, and the standard-sample 5920 and 5970 contained therein. Those reference-source signals within the solid angle subtended by the detector act like a ‘beam’ passing through a ‘slab’ of thickness (nd) 5918 of standard-sample 5920 or a ‘slab’ of thickness (md) 5968 of standard-sample 5970. Some fraction of the beam passes through the respective standard-sample unattenuated (dashed lines 5924 and 5974), and such fraction is called the nd or md sample-specific beam-transmitted-fraction (BmTrnsF_{Ei,stnd,nd} or BmTrnsF_{Ei,stnd,md}), respectively.

The signal detection, processing, preservation, and presentation subsystem 1630 acquires at least three spectral components as a single composite ‘gross’ spectrum (not shown) for each standard-sample counting; among the spectral components are the ambient background (not shown), reference-source beam 5924 and 5974, and the standard-sample emissions 5926 and 5976. To remove the ambient background component, subsystem 1630 normalizes the characteristic ambient background spectra to their associated standard-sample counting times, and then subtracts-out such normalized ambient background component spectra from their associated composite ‘gross’ spectra to produce their associated ‘net’ composite spectra (not shown), which are still comprised of at least two spectral components; i.e. the reference-source beam peaks and the standard-sample spectral peaks.

Once the ‘thin’ (nd) 5918 standard-sample counting is complete, a ‘thick’ (md) 5968 standard-sample can be prepared. There are two cases: In the first case, the cap 5912 to the sample container holding the already counted ‘thin’ (nd) 5918 standard-sample, is opened and additional standard-sample of the same composition is added to the same sample-container, filling the sample-container to create a relatively ‘thick’ (md) 5968 standard-sample, after which the cap to the sample-container is replaced and sealed tightly; and the ‘thick’ (md) 5968 standard-sample counting can begin.

In the second case, when dealing with standard-samples that may be used in recurring calibrations, two sample-containers of the same shape, size, and type are filled with the same standard-sample composition, but to different thicknesses (which are called, nd 5918 and md 5968). In the second case, after the first standard-sample is counted (and it could be either the ‘thin’ or ‘thick’ standard-sample), then the other standard-sample replaces the first in the detection system, and then it is also counted.

As with the first standard-sample counting, the second and subsequent standard-sample countings (should there be more than two standard-sample thicknesses) have their respective, normalized ambient background spectra subtracted-out from their associated composite ‘gross’ spectra to produce their associated ‘net’ composite spectra (not shown), which are still comprised of at least two spectral components; i.e. the reference-source beam peaks and the standard-sample spectral peaks.

To determine the sample-free detected-fraction calibration functions for each sample thickness [DetF (Eᵢ)_{smplFr,nd}, DetF (Eᵢ)_{smplFr,md}], a similar method is carried out as described in the discussion surrounding Equations [2a] to [30b], except the formulas carry an additional mass-ratio factor (RM_{stnd,nd:md}) that takes into account the ratio of the different masses of counted standard-samples, where:

$$\begin{matrix}sample ratio of the masses \text{:} {RM}_{stnd , nd : md} = \frac{{M}_{stnd , nd}}{{M}_{stnd , md}} & [ 39 ] \\ sample thickness \text{:} nd = ( \frac{n}{m} ) * md = ( \frac{{M}_{stnd , nd}}{{M}_{stnd , md}} ) * md & [ 40 a ] \\ sample mass \text{:} {M}_{stnd , md} = ( \frac{m}{n} ) * {M}_{stnd , nd} & [ 40 b ] \\ density ( σ ) equivalence \text{:} {σ}_{stnd , md} = {σ}_{stnd , nd} -> {σ}_{stnd} & [ 40 c ]\end{matrix}$$

Part 5. “nd: md” Beam-Assisted Multiple-Mass Sample Quantitation

It is presumed that the sample-free detected-fraction calibrations for each thickness of standard-sample have been determined (e.g., DetF_{Ei,smplFr,nd} and DetF_{Ei,smplFr,md}), after which analysis of one or more unknown-samples can begin.

An unknown-sample composition is prepared in one or more sample-containers to different depths and counted in a manner similar to that just outlined for the standard-sample, but without any external reference sources (i.e. only the unknown-sample itself is deliberately counted).

The processing of unknown-sample spectra is similar to that outlined in the first section of this disclosure for quantitating characteristic signal emitters in unknown-samples, except that in this case, to compute the specific-activity quantities (SpA_{Rj,unkn}) of the signal emitters (Rᵢ) in the unknown-sample, the formulas carry an additional mass-ratio factor (RM_{unkn,nd:md}) that takes into account the ratio of the different masses of counted unknown-sample, where:

$$\begin{matrix}sample ratio of the masses \text{:} {RM}_{unkn , nd : md} = \frac{{M}_{unkn , nd}}{{M}_{unkn , md}} & [ 41 ] \\ sample thickness \text{:} nd = ( \frac{n}{m} ) * md = ( \frac{{M}_{unkn , nd}}{{M}_{unkn , md}} ) * md & [ 42 a ] \\ sample mass \text{:} {M}_{unkn , md} = ( \frac{m}{n} ) * {M}_{unkn , nd} & [ 42 b ] \\ density ( σ ) equivalence \text{:} {σ}_{unkn , md} = {σ}_{unkn , nd} -> {σ}_{unkn} & [ 42 c ]\end{matrix}$$

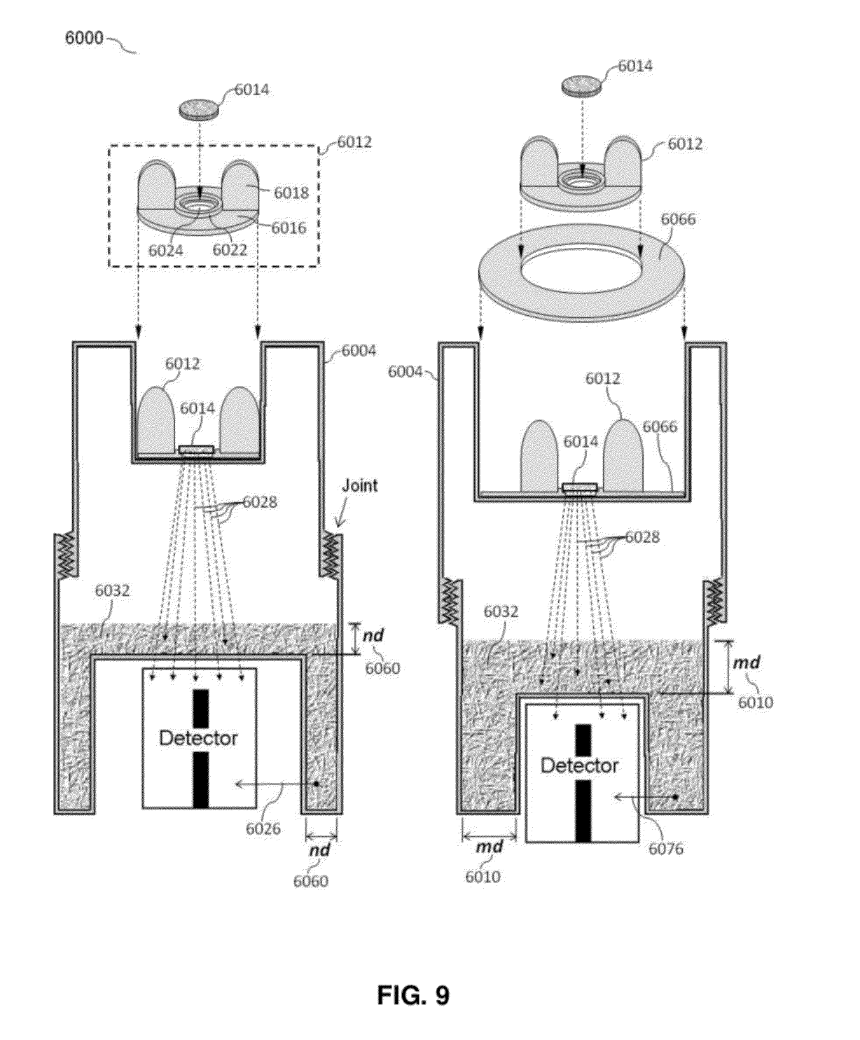

### Reference-Source Positioners for Wrap-Around Type Containers (FIG. 9)

FIG. 9 illustrates 6000 apparatuses 6004, 6012, and 6066. Double-sided ‘nd: md’ wrap-around sample-container apparatus 6004 is described in detail in the related U.S. patent application Ser. No. 13/049,903. In brief, the wrap-around sample-container 6004 consists of one side that forms the sample 6032 into a thin (nd, 6060) thickness with respect to the other side that forms the sample 6032 into a thicker (md, 6010) thickness when the wrap-around sample-container apparatus 6004 is flipped 180 degrees. Both sides of the wrap-around sample-container apparatus 6004 have an inside diameter that wraps around the detector when in one of the two (nd or md) sample counting positions. When in the thin (nd, 6060) counting position, some portion of the emitted characteristic signals 6026 from the sample are detected by the detector. When in the thick (md, 6010) counting position, some portion of the emitted characteristic signals 6076 from the sample are detected by the detector.

The narrow-diameter reference-source positioner 6012 consists of a base 6016; an elevated ridge 6022 that positions and secures the reference source 6014 in the center; a hollowed out section in the center consisting of a thin light-element (“low-Z”) ‘window’ 6024 to improve the transparency to the characteristic signals 6028 emanated by the reference-source 6014 in the direction of the standard-sample 6032 and detector; and raised tabs 6018 ('rabbit ears') that allow an operator to physically insert and remove the reference-source positioner from the recessed narrow- or wide-diameter portions of the wrap-around sample-container 6004. The rabbit ears 6018 may consist of any number of shapes to facilitate inserting and removing the reference-source positioner.

When the container is in the thin (nd, 6060) counting position, the narrow-diameter reference-source positioner 6012 can be sized to snugly fit into the small-diameter recess of the wrap-around sample-container 6004. When the wrap-around sample-container 6004 is in thick (md, 6010) counting position, then a reference-source positioner ring (“positioner ring” 6066) of the proper inner and outer diameters positions the narrow-diameter reference-source positioner 6012 in the center of the wide-diameter recess of the wrap-around sample-container. Alternatively, an additional wide-diameter reference-source positioner (not shown in FIG. 9) can be used to snugly fit into the wide-diameter recess of the wrap-around sample-container 6004 without the need for a positioner ring.

The reference-source 6014, reference-source positioner 6012, and positioner ring 6066 work combine in part or in whole to ensure repeatable reference-source beam lines that pass through the sample and allow computation of the linear attenuation coefficient of the sample composition and of the ratio of nd and md beam-derived sample-free detected-fraction calibration values (RDetF_{Eti,bm,nd:md}) as disclosed by Equations [20a] and [20b].

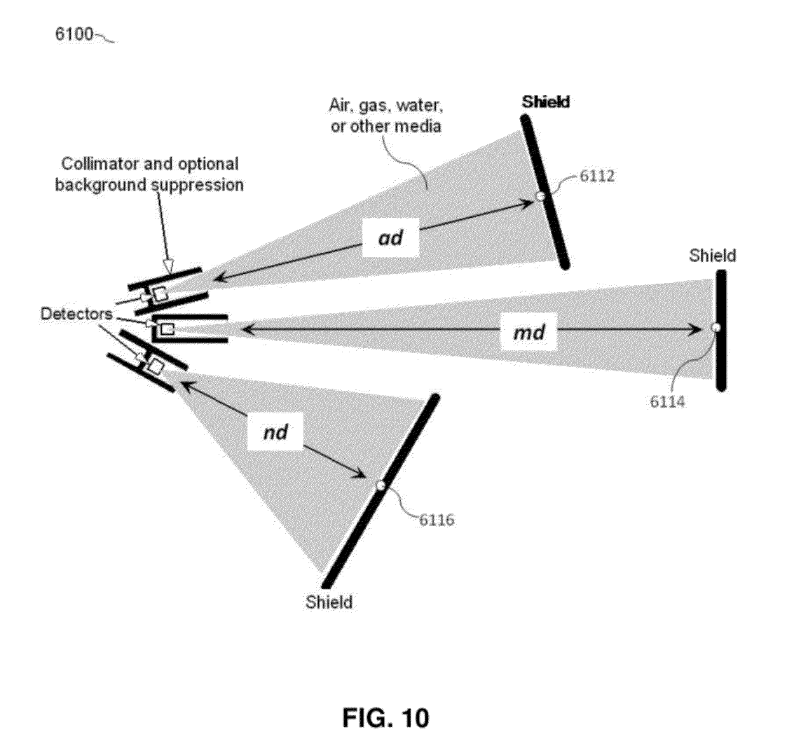

### Reference-Source Setup for Distant Signal Measurement (FIG. 10)

FIG. 10 illustrates 6100 a plurality of reference sources 6112, 6114, and 6116 at different distances from a plurality of detectors. The reference sources permit computing the ratio of nd, md, and ad beam-derived sample-free detected-fraction calibration values in the process disclosed by Equations [20a] and [20b]. The reference sources may be recessed into chambers (not shown) with electronically operated shutters or doors (not shown) that block the signals emitted from the reference sources in the direction of the plurality of detectors.

What is claimed is:

1. An apparatus for detecting radiation signals emitted from an unknown homogeneous sample, comprising:
a sample holder comprising a plurality of holder configurations, each holder configuration enabling measurement of the radiation signals emitted by the homogeneous sample via at least two different thicknesses;
an external radiation reference source having at least one prominent characteristic signal to allow signal beam-through the sample without interfering with the radiation signals emitted by the homogeneous sample, wherein the external reference source is held tight onto the sample holder by a positioning device;
a detector system comprising one or more detectors to detect the radiation signals from different homogeneous sample thicknesses; and
a computer to process the detected radiation signals and analyze the homogeneous sample composition by comparing the radiation signals from different homogeneous sample thicknesses by using a sample analysis software program.

2. The apparatus as in claim 1, wherein one of the sample holder configurations comprises a plurality of sample-container apparatuses, each sample-container apparatus having a different size and shape from other sample-container apparatuses such that the homogeneous sample forms different thicknesses when placed in different sample-container apparatuses.

3. The apparatus as in claim 2, wherein the sample-container apparatuses are connected with at least one shared opening to allow the homogeneous sample to transfer internally among the containers.

4. The apparatus as in claim 2, wherein the sample holder has two oppositely placed sample-container apparatuses connected with one shared opening to allow the homogeneous sample to transfer from one container to the other container when the sample holder is flipped 180 degrees.

5. The apparatus as in claim 4, wherein the two oppositely placed sample-container apparatuses are cylinders having predetermined diameters.

6. The apparatus as in claim 5, wherein the two oppositely placed sample-container apparatuses have their diameters in a ratio equal to \sqrt{2:1} such that the homogeneous sample thickness ratio is 1:2 when the homogeneous sample is transferred from one container to the other container.

7. The apparatus as in claim 5, wherein the two oppositely placed sample-container apparatuses have their diameters in a ratio equal to \sqrt{m}:\sqrt{n} such that the homogeneous sample thickness ratio is n:m when the homogeneous sample is transferred from one container to the other container.

8. The apparatus as in claim 4, wherein each of the two oppositely placed containers has an opening that can mate with the opening of the other container tightly.

9. The apparatus as in claim 1, wherein one of the sample holder configurations comprises a sample-container apparatus providing a different sample thickness relative to the detector system when the sample holder moves relative to the detector system.

10. The apparatus as in claim 9, wherein the sample in the sample-container apparatus has a rectangular cross section, wherein the short side and the long side of the rectangular container forms a ratio of a:b, wherein 0<a<b.

11. The apparatus as in claim 4, wherein the sample-container apparatus is a double-sided wrap-around type.

12. The apparatus as in claim 4, wherein the sample-container apparatus is a Marinelli-type container.

13. The apparatus as in claim 4, wherein the sample-container apparatus is a double-sided cylinder.

14. The apparatus as in claim 4, wherein the sample-container apparatus is a well-type container.

15. The detector system as in claim 1, comprising a plurality of detectors capable of detecting radiation signals emitted from the homogeneous sample in a predetermined energy range.

16. The apparatus as in claim 1, the external radiation reference source is held tightly by a reference source positioner device including an orifice securing the reference source.

17. The positioner device in claim 16, further comprises a handle for lifting the reference source positioner.

18. The positioner device in claim 16, further comprises a window in the orifice to passing the radiation from the reference source.

19. The positioner device in claim 16, further comprises an adapter ring to fit the positioner device to a different diameter sample container.

20. The software program as in claim 1 is built based on a physics model.

21. The apparatus as in claim 1, further comprising a homogeneous standard-sample emitting radiation signals in an energy range similar to the homogeneous unknown-sample to be measured.

22. The apparatus as in claim 1, wherein the software program comprises:
a signals input module for reading emitted signals from the homogeneous sample;
a background signal subtraction module;
a signal matching module, wherein each matched signal is emitted from a different thickness of the homogeneous sample;
a sample-specific escaped-fraction computation module, wherein the module comprises a first algorithm operating on signal count rates of different thicknesses of the homogeneous sample;
an external source calibration module; and
a sample quantitation module.

23. The software program as in claim 22, further comprising a data qualification module comprising default or optional user-chosen qualification intervals.

24. The software program as in claim 23, further comprising a presentation module, wherein default or optional user-chosen colors for presentation purposes are assigned to qualification intervals.

25. The software program as in claim 22, further comprising a module for default or optional user-chosen removal of computed values of the sample-specific escaped-fraction term, wherein the default removal is based on qualification intervals.

26. The software program as in claim 25, further comprising a second algorithm, wherein the second algorithm comprises:
program codes to get the sum of the peak count rates,
program codes to get the difference of the peak count rates,
program codes to operate on the sum and difference of the peak count rates to improve the statistics.

27. A method for characterizing radiation signals emitted from an unknown homogeneous sample, the method comprising:
providing a radiation signal detector system comprising a plurality of detectors, a computer for analyzing the sample, and a sample holder, wherein the sample holder includes a plurality of containers, each sample-container apparatus has a different size from other sample-container apparatuses, such that the homogeneous sample forms different thickness when placed in different sample-container apparatuses;
performing background signal detection for each empty sample-container apparatus and determining a background signal count rate for each empty sample-container apparatus;
performing reference signal detection by measuring a reference source emission having at least one prominent characteristic signal to allow signal beam-through the plurality of empty sample containers and the plurality of containers with the sample;
performing calibration signal detection by measuring a standard-sample and the reference source emission sequentially in each sample-container apparatus and determining a standard signal count rate for each sample-container apparatus;
subtracting the background signal count rate from standard-sample signals for each container;
performing a ratio computation of detected fraction calibrations for two different sample thicknesses;
performing the signal detection for the unknown homogeneous sample in each sample-container apparatus;
subtracting the background signal count rate from the unknown homogeneous sample signals for each container;
measuring the characteristic signal count rates for the unknown-sample in each sample-container apparatus;
verifying the characteristic signal count rates to be qualified data; and
calculating the composition of the unknown homogeneous sample by comparing the characteristic signal count rates of the unknown-sample from different sample-container apparatuses using a software model.

28. The method as in claim 27, the ratio computation further comprises:
measuring the first reference source emission signal through one empty sample container;
measuring the second reference source emission signal through one sample container with the sample of a first thickness; and
calculating the ratio of the second to the first signals.

29. The method as in claim 28, the ratio computation further comprises:
measuring the third reference source emission signal through one sample container with the sample of a second thickness; and
calculating the ratio of the third to the first signals.

30. A method for characterizing radiation signals emitted from an unknown homogeneous sample, the method comprising:
providing a radiation signal detector system comprising a plurality of detectors, a computer for analyzing the sample, and a sample holder, wherein the sample holder includes a plurality of containers, each sample-container apparatus has a different size from other sample-container apparatuses, such that the homogeneous sample forms different thickness when placed in different sample-container apparatuses;
performing background signal detection for each empty sample-container apparatus and determining a background signal count rate for each empty sample-container apparatus;
performing reference signal detection by measuring a reference source emission having at least one prominent characteristic signal to allow signal beam-through the plurality of containers with the sample;
performing calibration signal detection by measuring a standard-sample and the reference source emission sequentially in each sample-container apparatus and determining a standard signal count rate for each sample-container apparatus;
subtracting the background signal count rate from standard-sample signals for each container;
performing a ratio computation of detected fraction calibrations for two different sample thicknesses, wherein the ratio computation includes measuring the reference source emission signals through the sample of the first and the second thicknesses, and calculating the ratio of the signal from the thicker thickness to the thinner thickness;
performing the signal detection for the unknown homogeneous sample in each sample-container apparatus;
subtracting the background signal count rate from the unknown homogeneous sample signals for each container;
measuring the characteristic signal count rates for the unknown-sample in each sample-container apparatus;
verifying the characteristic signal count rates to be qualified data; and
calculating the composition of the unknown homogeneous sample by comparing the characteristic signal count rates of the unknown-sample from different sample-container apparatuses using a software model.

31. The method as in claim 30, wherein the sample holder has two oppositely placed containers connected with one shared opening, and wherein performing the signal detection includes flipping the sample holder 180 degrees to allow the homogeneous sample transferring from one container to the other.

32. The method as in claim 31, wherein the two oppositely placed sample-container apparatuses are cylinders having predetermined diameters.

33. The method as in claim 32, wherein the two oppositely placed sample-container apparatuses have their diameters ratio equal to \sqrt{2}:1 and the sample thickness ratio is 1:2.

34. The apparatus as in claim 32, wherein the two oppositely placed sample-container apparatuses have their diameters in a ratio equal to \sqrt{m}:\sqrt{n} such that the homogeneous sample thickness ratio is n:m when the homogeneous sample is transferred from one container to the other container.

35. The method as in claim 30, wherein the signal detection for all sample-container apparatuses is performed sequentially.

36. A method for characterizing radiation signals emitted from an unknown homogeneous sample, the method comprising:
providing a radiation signal detecting system comprising a plurality of detectors, a computer for analyzing the sample composition, and two sample-containers each having the same shape;
filling the first sample-container with a first amount of the unknown homogeneous sample;
filling the second sample-container with a second amount of the unknown homogeneous sample;
performing background signal detection for each sample-container and determining a background signal count rate for each sample;
performing reference source signal detection;
performing calibration signal detection by measuring a standard sample and the reference source emission detection sequentially in each sample-container apparatus position and determining a standard signal count rate for each sample-container;
subtracting the background signal count rate from standard sample signals for each container;
performing a ratio computation of detected fraction calibrations for two different sample thicknesses;
performing the signal detection for the first unknown homogeneous sample in the first sample-container and the second unknown homogeneous sample in the second sample-container;
subtracting the background signal count rate from the first and second unknown homogeneous sample signals;
measuring the characteristic signal count rates for the first and second unknown samples;
verifying the characteristic signal count rates to be qualified data; and
calculating the composition of the first and second unknown homogeneous samples by comparing the characteristic signal count rates of the first and second unknown samples using a software model.

37. The method as in claim 36, the ratio computation further comprises:
measuring the first reference source emission signal through one empty sample container;
measuring the second reference source emission signal through one sample container with the sample of a first thickness; and
calculating the ratio of the second to the first signals.

38. The method as in claim 37, the ratio computation further comprises:
measuring the third reference source emission signal through one sample container with the sample of a second thickness; and
calculating the ratio of the third to the first signals.

39. A method for characterizing radiation signals emitted from an unknown homogeneous sample, the method comprising:
providing a radiation signal detecting system comprising a plurality of detectors, a computer for analyzing the sample composition, and two sample-containers each having the same shape;
filling the first sample-container with a first amount of the unknown homogeneous sample;
filling the second sample-container with a second amount of the unknown homogeneous sample;
performing background signal detection for each sample-container and determining a background signal count rate for each sample;
performing reference source signal detection;
performing calibration signal detection by measuring a standard sample and the reference source emission detection sequentially in each sample-container apparatus position and determining a standard signal count rate for each sample-container;
subtracting the background signal count rate from standard sample signals for each container;
performing a ratio computation of detected fraction calibrations for two different sample thicknesses, wherein the ratio computation includes measuring the reference source emission signals through the sample of the first and second thicknesses, and calculating the ration of the signals from the thicker thickness to the thinner thickness;
performing the signal detection for the first unknown homogeneous sample in the first sample-container and the second unknown homogeneous sample in the second sample-container;
subtracting the background signal count rate from the first and second unknown homogeneous sample signals;
measuring the characteristic signal count rates for the first and second unknown samples;
verifying the characteristic signal count rates to be qualified data; and
calculating the composition of the first and second unknown homogeneous samples by comparing the characteristic signal count rates of the first and second unknown samples using a software model.

40. The method as in claim 39, wherein verifying the characteristic signal count rates includes signal peak identification and correction.

41. A system for identifying radiation signals emitted from an unknown homogeneous sample, comprising:
a sample holder comprising a plurality of sample holder configurations, each sample holder configuration enabling measurement of the homogeneous sample via at least two different thicknesses;
a detector system to detect the radiation signals from different sample thicknesses, comprising at least one detector capable of detecting radiation signals emitted from the homogeneous sample in a predetermined energy range;
an external radiation reference source having at least one prominent characteristic signal to allow signal beam-through the sample without interfering with the radiation signal emitted by the homogeneous sample;
a standard sample emitting radiation signals in an energy range similar to the homogeneous sample to be measured; and
a software program capable of handing reading emitted signals from sample-container apparatuses, measuring a background signal, measuring an external reference signal, calibrating the standard sample, verifying and qualifying each signal peak in emitted signal spectrum from each sample-container apparatus, correcting emitted sample signal from each sample-container apparatus; and analyzing sample composition using a composition database; and a computer to process the detected signals and analyze the sample composition by comparing radiation signals at different sample thicknesses from different containers by using the software program.

42. The system as in claim 41, wherein one of the sample holder configurations comprises a plurality of sample-container apparatuses, each sample-container apparatus having a different size and shape from other sample-container apparatuses, so the homogeneous sample forms different thickness when placed in different sample-container apparatuses.

43. The system for identifying radiation signals as in claim 41, wherein the sample holder has two oppositely placed containers connected with one shared opening to allow the homogeneous sample transferring from one container to the other container when the sample holder is flipped 180 degrees;
wherein the two oppositely placed sample-container apparatuses are cylinders having predetermined diameters.

44. The system as in claim 43, the two oppositely placed sample-container apparatuses have their diameters ratio equal to \sqrt{2:1} and the sample thickness ratio is 1:2 when the homogeneous sample is transferred from one container to the other container.

45. The apparatus as in claim 43, wherein the two oppositely placed sample-container apparatuses have their diameters in a ratio equal to \sqrt{m}:\sqrt{n} such that the homogeneous sample thickness ratio is n:m when the homogeneous sample is transferred from one container to the other container.

46. The system as in claim 41, wherein one of the sample holder configurations comprises a sample-container apparatus providing different sample thicknesses when the sample holder moves relative to the detector system.

47. The system as in claim 44, wherein the sample in the sample-container apparatus has a rectangular cross section.

48. The system as in claim 47, wherein the long side and the short side of the rectangular container forms a ratio of a:b, wherein 0<a<b.

49. A software product embedded in a computer readable medium for providing analysis in material spectra characterization, the software product comprising:
program codes for reading the emitted signals from the homogeneous sample;
program codes for subtracting a background signal;
program codes for subtracting a reference source emission signal;
program codes for matching signals emitted from a different thickness of the homogeneous sample;
program codes for operating on signal count rates of different thicknesses of the homogeneous sample;
program codes for calibrating a standard sample signals, including one of the three sets of codes:
1) codes for measuring a first reference source emission signal through one empty sample container;
codes for measuring a second reference source emission signal through one sample container with the sample at a first thickness;
codes for calculating the ratio of the second to the first signals for the first thickness;
2) codes for measuring a second reference source emission signal through one sample container with the sample at a first thickness;
codes for measuring a third reference source emission signal through one sample container with the sample at a second thickness;
codes for calculating the ratio of the third to the first signals for the second thickness;
3) codes for measuring the reference source emission signal through the sample of the first and second thickness;
codes for calculating the ratio of the signals from the thicker thickness to the thinner thickness; and
program codes for quantization of the material spectra.

50. The software product as in claim 49, further comprising program codes to choose a default or optional user-chosen intervals.

51. The software product as in claim 50, further comprising program codes to present default or optional user-chosen colors as qualification intervals.
